(19) United States
(12) Patent Application Publication
(10) Pub. No.: US 2021/0213702 A1
(43) Pub. Date: Jul. 15, 2021

(54) NONWOVEN ARTICLE

(71) Applicants: SAINT-GOBAIN ABRASIVES, INC., Worcester, MA (US); SAINT-GOBAIN ABRASIFS, Conflans-Sainte-Honorine (FR)

(72) Inventors: Vinayak OGALE, Chennai (IN); Veeraraghavan SRINIVASAN, Chennai (IN); Manisha MOHAPATRA, Orissa (IN); Mitul D. ZAVERI, Bangalore (IN); Sumi DINKAR, Bangalore (IN); Brahmanandam V. TANIKELLA, Northborough, MA (US)

(21) Appl. No.: 17/120,822

(22) Filed: Dec. 14, 2020

Related U.S. Application Data
(60) Provisional application No. 63/046,326, filed on Jun. 30, 2020.
(60) Provisional application No. 63/046,338, filed on Jun. 30, 2020.

(30) Foreign Application Priority Data
Dec. 17, 2019 (IN) 201941052275
Dec. 17, 2019 (IN) 201941052276

(51) Int. Cl. B32B 3/26; B32B 5/02; B32B 27/12

(52) U.S. Cl. CPC B32B 3/263; B32B 5/022; B32B 27/12; B32B 2307/7145; B32B 2307/724; B32B 2307/726; B32B 2307/514; B32B 2307/558

(57) ABSTRACT

A nonwoven article includes a nonwoven substrate having from a lofty, open web of fibers formed through a needling process. The nonwoven substrate is coated with at least one coating to provide improved performance characteristics including loft, elongation, tensile strength, stiffness, pore size, permeability, fiber orientation index, and combinations thereof.

### CROSS-REFERENCE TO RELATED APPLICATIONS

This application claims priority to and the benefit of U.S. Provisional Patent Application No. 63/046,338, filed on Jun. 30, 2020, by Vinayak OGALE et al., entitled “NONWOVEN ARTICLE,” and claims priority to and the benefit of U.S. Provisional Patent Application No. 63/046,326, filed on Jun. 30, 2020, by Vinayak OGALE et al., entitled “NONWOVEN ARTICLE,” and claims priority to and the benefit of Indian Patent Application No. 201941052276, filed on Dec. 17, 2019, by Vinayak OGALE et al., entitled “NONWOVEN ARTICLE,” and claims priority to and the benefit of Indian Patent Application No. 201941052275, filed on Dec. 17, 2019, by Vinayak OGALE et al., entitled “NONWOVEN ARTICLE,” the disclosures of which are assigned to the current assignee hereof and incorporated herein by reference in their entireties for all purposes.

### BACKGROUND

Nonwoven articles having a lofty, open web of fibers are used in various applications and often employed as a substrate for a wide variety of abrasive articles. Nonwoven articles can often be engineered to provide performance characteristics specific to a particular application that includes workpiece surfaces having complex shapes, delicate surface finishes, and/or deposits or residue that require a combination of performance characteristics to provide satisfactory cleaning and//or finishing. Accordingly, there continues to be a need for improved nonwoven articles having improved performance characteristics.

### BRIEF DESCRIPTION OF THE DRAWINGS

The present disclosure may be better understood, and its numerous features and advantages made apparent to those skilled in the art by referencing the accompanying drawings.

FIG. 1 is an oblique view of a nonwoven article according to an embodiment of the disclosure.

FIG. 2 is an oblique close-up view of a portion of a nonwoven article according to an embodiment of the disclosure.

FIG. 3 is an oblique close-up view of a portion of a nonwoven article according to an embodiment of the disclosure.

FIG. 4 is a flowchart of a method of forming a nonwoven article according to an embodiment of the disclosure.

FIG. 5 is an image of a nonwoven article according to an embodiment of the disclosure.

FIG. 6 is a microscopic image of a top of a nonwoven article according to an embodiment of the disclosure.

FIG. 7 is another microscopic image of a top of a nonwoven article according to an embodiment of the disclosure.

FIG. 8 is a microscopic image of a side of a nonwoven article according to an embodiment of the disclosure.

FIG. 9 is another microscopic image of a side of a nonwoven article according to an embodiment of the disclosure.

FIG. 10 is a microscopic image of a top of a control nonwoven article.

FIG. 11 is another microscopic image of a top of a control nonwoven article.

FIG. 12 is a microscopic image of a side of a control nonwoven article.

FIG. 13 is another microscopic image of a side of a control nonwoven article.

FIG. 14 is an oblique close-up view of a portion of a nonwoven article according to an embodiment of the disclosure.

The use of the same reference symbols in different drawings indicates similar or identical items.

### DETAILED DESCRIPTION

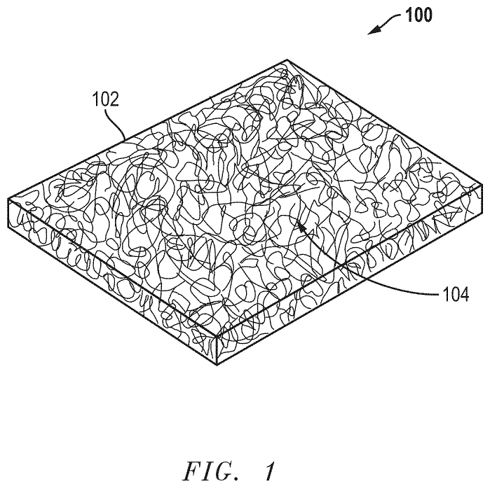

FIG. 1 shows an oblique view of a nonwoven article 100 according to an embodiment of the disclosure. The nonwoven article 100 may generally comprise a nonwoven substrate 102. The nonwoven substrate 102 may comprise a lofty, open web formed from a plurality of fibers 104. Further, in some embodiments, the nonwoven substrate 102 may comprise a single monolithic substrate. In some embodiments, the plurality of fibers 104 may be subjected to a needle punching process to at least partially entangle and/or intermingle the plurality of fibers 104 to form the nonwoven substrate 102. In a particular embodiment, the needle punching process may comprise a double needling process.

In a particular embodiment, the needle punching process may comprise a single needling process utilizing a single needling board. In some embodiments, the single needling process may comprise a needling stroke of at least about 75 revolutions/square centimeter (rev/cm²), such as at least 76 rev/cm², at least 77 rev/cm², at least 78 rev/cm², at least 79 rev/cm², at least 80 rev/cm², at least 81 rev/cm², at least 82 rev/cm², at least 83 rev/cm², at least 84 rev/cm², or even at least about 85 rev/cm². In some embodiments, the single needling process may comprise a needling stroke of not greater than about 90 rev/cm², such as not greater than 85 rev/cm², such as not greater than 84 rev/cm², not greater than 83 rev/cm², not greater than 82 rev/cm², not greater than 81 rev/cm², not greater than 80 rev/cm², not greater than 79 rev/cm², not greater than 78 rev/cm², not greater than 77 rev/cm², or even not greater than about 76 rev/cm². Further, it will be appreciated that the single needling process may comprise a needling stroke between any of these minimum and maximum values, such as at least about 75 rev/cm² to not greater than about 90 rev/cm².

In some embodiments, the single needling process may comprise a needling depth (i.e., penetration into the nonwoven substrate 102) of at least about 3.5 millimeters (mm), such as at least 3.6 mm, at least 3.7 mm, at least 3.8 mm, at least 3.9 mm, at least 4.0 mm, at least 4.1 mm, at least 4.2 mm, at least 4.3 mm, at least 4.3 mm, at least 4.4 mm, at least 4.5 mm, at least 4.6 mm, at least 4.7 mm, at least 4.8 mm, at least 4.9 mm, at least 5.0 mm, at least 5.1 mm, at least 5.2 mm, at least 5.3 mm, at least 5.4 mm, or even at least about 5.5 mm. In some embodiments, the single needling process may comprise a needling depth of not greater than about 6.5 mm, such as not greater than 6.4 mm, not greater than 6.3 mm, mm, not greater than 6.2 mm, not greater than 6.1 mm, not greater than 6.0 mm, not greater than 5.9 mm, not greater than 5.8 mm, not greater than 5.7 mm, not greater than 5.6 mm, or even not greater than about 5.5 mm. Further, it will be appreciated that the single needling process may comprise a needling depth between any of these minimum and maximum values, such as at least about 3.5 mm to not greater than about 6.5 mm.

In another particular embodiment, the needle punching process may comprise a double needling process. The double needling process may generally comprise two needling boards that operate at different parameters to at least partially entangle and/or intermingle the plurality of fibers 104 to form the nonwoven substrate 10s at various needling depths, strokes, or combinations thereof. In some embodiments, the first needling board of the double needling process may comprise a needling stroke of at least about 75 revolutions/square centimeter (rev/cm²), such as at least 76 rev/cm², at least 77 rev/cm², at least 78 rev/cm², at least 79 rev/cm², at least 80 rev/cm², at least 81 rev/cm², at least 82 rev/cm², at least 83 rev/cm², at least 84 rev/cm², or even at least about 85 rev/cm². In some embodiments, the first needling board of the double needling process may comprise a needling stroke of not greater than about 120 rev/cm², such as not greater than 110 rev/cm², not greater than 100 rev/cm², not greater than 95 rev/cm², not greater than 90 rev/cm², not greater than 89 rev/cm², not greater than 88 rev/cm², not greater than 87 rev/cm², not greater than 86 rev/cm², or even not greater than 85 rev/cm². Further, it will be appreciated that the first board of the double needling process may comprise a needling stroke between any of these minimum and maximum values, such as at least about 75 rev/cm² to not greater than about 120 rev/cm², or even such as at least about 80 rev/cm² to not greater than about 85 rev/cm².

In some embodiments, the first needling board of the double needling process may comprise a needling depth (i.e., penetration into the nonwoven substrate 102) of at least about 3.0 millimeters (mm), such as at least 3.2 mm, at least 3.4 mm, at least 3.6 mm, at least 3.8 mm, at least 4.0 mm, at least 4.2 mm, at least 4.4 mm, at least 4.6 mm, at least 4.8 mm, at least 5.0 mm, at least 5.2 mm, at least 5.4 mm, at least 5.6 mm, at least 5.8 mm, at least 6.0 mm, at least 6.2 mm, at least 6.4 mm, at least 6.6 mm, at least 6.8 mm, at least 7.0 mm, at least 7.2 mm, at least 7.4 mm, at least 7.6 mm, at least 7.8 mm, at least 8.0 mm, at least 8.2 mm, at least 8.4 mm, at least 8.6 mm, at least 8.8 mm, at least 9.0 mm, at least 9.2 mm, at least 9.4 mm, at least 9.6 mm, at least 9.8 mm, at least 9.0 mm, at least 9.2 mm, at least 9.4 mm, at least 9.6 mm, at least 9.8 mm, or even at least about 10.0 mm. In some embodiments, the first needling board of the double needling process may comprise a needling depth of not greater than about 15 mm, such as not greater than 14.5 mm, not greater than 14 mm, mm, not greater than 13.5 mm, not greater than 13 mm, not greater than 12.5 mm, not greater than 12 mm, not greater than 11.5 mm, or even not greater than about 11 mm. Further, it will be appreciated that the first needling board of the double needling process may comprise a needling depth between any of these minimum and maximum values, such as at least about 3.0 mm to not greater than about 15 mm, or even such as at least about 3.4 mm to not greater than 11 mm.

In some embodiments, the second needling board of the double needling process may comprise a needling stroke of at least about 90 revolutions/square centimeter (rev/cm²), such as at least 100 rev/cm², at least 105 rev/cm², at least 110 rev/cm², at least 115 rev/cm², at least 116 rev/cm², at least 117 rev/cm², at least 118 rev/cm², at least 119 rev/cm², or even at least about 120 rev/cm². In some embodiments, the second needling board of the double needling process may comprise a needling stroke of not greater than about 150 rev/cm², such as not greater than 140 rev/cm², not greater than 130 rev/cm², not greater than 125 rev/cm², or even not greater than 120 rev/cm². Further, it will be appreciated that the first board of the double needling process may comprise a needling stroke between any of these minimum and maximum values, such as at least about 90 rev/cm² to not greater than about 150 rev/cm², or even such as at least about 95 rev/cm² to not greater than about 120 rev/cm².

In some embodiments, the second needling board of the double needling process may comprise a needling depth (i.e., penetration into the nonwoven substrate 102) of at least about 1.0 millimeters (mm), such as at least 1.5 mm, at least 2.0 mm, at least 2.5 mm, at least 3.0 mm, at least 3.1 mm, at least 3.2 mm, at least 3.3 mm, at least 3.4 mm, at least 3.5 mm, at least 3.6 mm, at least 3.8 mm, at least 4.0 mm, at least 4.2 mm, at least 4.4 mm, at least 4.6 mm, at least 4.8 mm, at least 5.0 mm, at least 5.2 mm, at least 5.4 mm, at least 5.6 mm, at least 5.8 mm, at least 6.0 mm, at least 6.2 mm, at least 6.4 mm, at least 6.6 mm, at least 6.8 mm, at least 7.0 mm, at least 7.2 mm, at least 7.4 mm, at least 7.6 mm, at least 7.8 mm, at least 8.0 mm, at least 8.2 mm, at least 8.4 mm, at least 8.6 mm, at least 8.8 mm, at least 9.0 mm, at least 9.2 mm, at least 9.4 mm, at least 9.6 mm, at least 9.8 mm, at least 9.0 mm, at least 9.2 mm, at least 9.4 mm, at least 9.6 mm, at least 9.8 mm, or even at least about 10.0 mm. In some embodiments, the second needling board of the double needling process may comprise a needling depth of not greater than about 15 mm, such as not greater than 14.5 mm, not greater than 14 mm, mm, not greater than 13.5 mm, not greater than 13 mm, not greater than 12.5 mm, not greater than 12 mm, not greater than 11.5 mm, not greater than 11 mm, not greater than 10.5 mm, or even not greater than about 10.12 mm. Further, it will be appreciated that the first needling board of the double needling process may comprise a needling depth between any of these minimum and maximum values, such as at least about 1.0 mm to not greater than about 15 mm, or even such as at least about 3.2 mm to not greater than 10.12 mm.

In some embodiments, the plurality of fibers 104 may be substantially similar. In some embodiments, the plurality of fibers 104 may be a blend of different fibers 104. Accordingly, in some embodiments, the blend of different fibers 104 may comprise a first type of fibers and a second type of fibers. In particular embodiments, the first type of fibers may be different from the second type of fibers in composition, construction, denier, length, ratio, shape, thickness, type, or any combination thereof.

In some embodiments, the denier of the first type of fibers may be different from the denier of the second type of fibers by at least about 5%, such as at least 10%, at least 15%, at least 20%, at least 25%, at least 30%, at least 35%, at least 40%, at least 45%, at least 50%, at least 55% as at least 60%, at least 65%, at least 70%, at least 75%, at least 80%, at least 85%, at least 90%, at least 95%, at least 100%, at least 150%, at least 200%, at least 300%, at least 400%, at least 500%, at least 1000%, or even at least about 2000%. In some embodiments, the denier of the first type of fibers may be different from the denier of the second type of fibers by not greater than about 2000%, not greater than 1000%, not greater than 500%, not greater than 400%, not greater than 300%, not greater than 200%, not greater than 100%, not greater than 95% of the plurality of fibers 104, such as not greater than 90%, not greater than 85%, not greater than 80%, not greater than 75%, not greater than 70%, not greater than 65%, not greater than 60%, not greater than 55%, not greater than 50%, not greater than 45%, not greater than 40%, not greater than 35%, not greater than 30%, not greater than 25%, not greater than 20%, not greater than 15%, not greater than 10%, or even not greater than about 5%. Further, it will be appreciated that denier of the first type of fibers may be different from the denier of the second type of fibers by between any of these minimum and maximum percentages, such as at least about 5% to not greater than about 2000% of the plurality of fibers 104. Furthermore, at least in some embodiments, the ratio of the denier of the first type of fibers to the denier of the second type of fibers may be between about 1:1 to about 1:20.

In some embodiments, the first type of fibers may comprise at least about 5% of the plurality of fibers 104, such as at least 10%, at least 15%, at least 20%, at least 25%, at least 30%, at least 35%, at least 40%, at least 45%, at least 50%, at least 55% as at least 60%, at least 65%, at least 70%, at least 75%, at least 80%, at least 85%, at least 90%, or even at least 95% of the plurality of fibers 104. In some embodiments, the first type of fibers may comprise not greater than about 95% of the plurality of fibers 104, such as not greater than 90%, not greater than 85%, not greater than 80%, not greater than 75%, not greater than 70%, not greater than 65%, not greater than 60%, not greater than 55%, not greater than 50%, not greater than 45%, not greater than 40%, not greater than 35%, not greater than 30%, not greater than 25%, not greater than 20%, not greater than 15%, not greater than 10%, or even not greater than about 5% of the plurality of fibers 104. Further, it will be appreciated that the percentage of the first type of fibers may be between any of these minimum and maximum percentages, such as at least about 5% to not greater than about 95% of the plurality of fibers 104.

In some embodiments, the second type of fibers may comprise at least about 5% of the plurality of fibers 104, such as at least 10%, at least 15%, at least 20%, at least 25%, at least 30%, at least 35%, at least 40%, at least 45%, at least 50%, at least 55% as at least 60%, at least 65%, at least 70%, at least 75%, at least 80%, at least 85%, at least 90%, or even at least about 95% of the plurality of fibers 104. In some embodiments, the second type of fibers may comprise not greater than about 95% of the plurality of fibers 104, such as not greater than 90%, not greater than 85%, not greater than 80%, not greater than 75%, not greater than 70%, not greater than 65%, not greater than 60%, not greater than 55%, not greater than 50%, not greater than 45%, not greater than 40%, not greater than 35%, not greater than 30%, not greater than 25%, not greater than 20%, not greater than 15%, not greater than 10%, or even not greater than about 5% of the plurality of fibers 104. Further, it will be appreciated that the percentage of the second type of fibers may be between any of these minimum and maximum percentages, such as at least about 5% to not greater than about 95% of the plurality of fibers 104.

In some embodiments, the nonwoven substrate 102 may comprise a weight, measured in grams per square meter and commonly referred to in the art as “GSM”. In some embodiments, the nonwoven substrate 102 may comprise a weight of at least about 350 GSM, such at least 360 GSM, 370 GSM, 380 GSM, 390 GSM, 400 GSM, 425 GSM, or even at least about 450 GSM. In some embodiments, the nonwoven substrate 102 may comprise a weight of not greater than about 700 GSM, such as not greater than 650 GSM, not greater than 600 GSM, not greater than 550 GSM, not greater than 540 GSM, not greater than 530 GSM, not greater than 520 GSM, not greater than 510 GSM, or even not greater than 500 GSM. Further, it will be appreciated that the weight of the nonwoven substrate 102 may be between any of these minimum and maximum weights, such as at least about 350 GSM to not greater than about 700 GSM, or even such as at least about 450 GSM to not greater than 500 GSM.

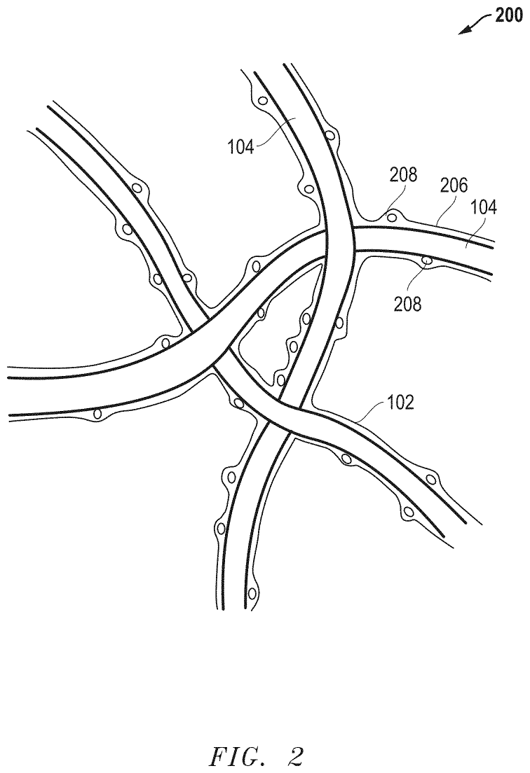

FIG. 2 shows an oblique close-up view of a portion of a nonwoven article 200 according to an embodiment of the disclosure. The nonwoven article 200 may be substantially similar to and formed in a substantially similar manner to nonwoven article 100. The nonwoven article 200 may generally comprise a nonwoven substrate 102 comprising a lofty, open web formed from a plurality of fibers 104. However, the nonwoven article 200 may also comprise a first coating 206 adhered to and/or overlying the plurality of fibers 104 of the nonwoven substrate 102. In some embodiments, the first coating 206 may be applied as a dip coating, a spray coating, or any combination thereof. The first coating 206 may generally comprise a polymeric composition formed from a single polymer or a blend of polymers. Additionally, in some embodiments, the first coating 206 may also comprise a plurality of abrasive particles 208 disposed in the polymeric composition to form an abrasive article.

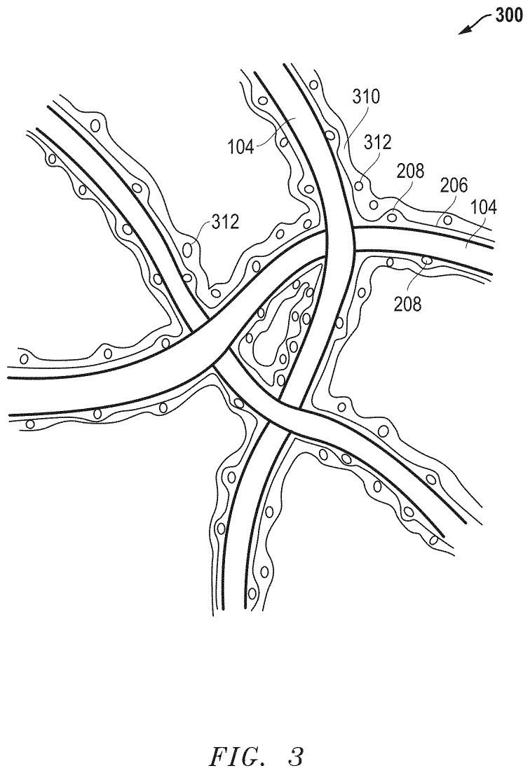

FIG. 3 shows an oblique close-up view of a portion of a nonwoven article 300 according to an embodiment of the disclosure. The nonwoven article 300 may be substantially similar to and formed in a substantially similar manner to nonwoven article 200. The nonwoven article 300 may generally comprise a nonwoven substrate 102 comprising a lofty, open web formed from a plurality of fibers 104 and a first coating 206 adhered to and/or overlying the plurality of fibers 104 of the nonwoven substrate 102. However, the nonwoven article 300 may also comprise a second coating 310 adhered to and/or overlying the first coating 206. In some embodiments, the second coating 310 may be applied as a spray coating, a dip coating, or any combination thereof. The second coating 310 may generally comprise a polymeric composition formed from a single polymer or a blend of polymers. Additionally, in some embodiments, the second coating 310 may also comprise a plurality of abrasive particles 312 disposed in the polymeric composition to form an abrasive article.

In some embodiments, the first coating 206 may be substantially similar to the second coating 310. In some embodiments, the first coating 206 may comprise a substantially similar polymeric composition that the second coating 310. In some embodiments, the abrasive grains 208 in the first coating 208 may be substantially similar in composition, size, type, dry or wet weight percentage, or any combination thereof to the abrasive grains 312 in the second coating 310. However, in some embodiments, the first coating 206 may be different from the second coating 310. In some embodiments, the first coating 206 may comprise a different polymeric composition that the second coating 310. In some embodiments, the first coating 206 may comprise abrasive particles 206, while the second coating 310 is free of abrasive particles 312. In some embodiments, the first coating 206 may be free of abrasive particles, while the second coating 310 comprises abrasive particles 312. In some embodiments, abrasive grains 208 in the first coating 206 may be different in composition, size, type, dry or wet weight percentage, or any combination thereof to the abrasive grains 312 in the second coating 310.

In a particular embodiment, the first coating 206 may be applied as a dip coating (i.e., by dipping or submerging the nonwoven substrate 102 in the first coating 206 mixture), and the second coating 310 may be applied as a spray coating (i.e., by spraying the second coating 310 mixture onto the nonwoven substrate 102 and at least partially over the first coating 206). In some embodiments, the dipping process of applying the first coating 206 may allow the first coating 206 to penetrate the lofty, open web of the plurality of fibers 104 to substantially coat a central portion and exterior surfaces of the nonwoven substrate 102, while the spraying process of applying the second coating 310 may only partially penetrate the lofty, open web of the plurality of fibers 104 to only partially coat the central portion of the nonwoven substrate 102 and substantially coat the exterior surfaces of the nonwoven substrate 102. Accordingly, in some embodiments, the overall coating (sum of the first coating 206 and the second coating 310) may have a greater thickness at an exterior surface of the nonwoven substrate 102 as compared to the thickness of the overall coating at the central portion of the nonwoven substrate 102.

In some embodiments, the thickness of the overall coating at an exterior surface of the nonwoven substrate 102 may be greater than the thickness of the overall coating at the central portion of the nonwoven substrate 102 by at least about 1%, such as at least 2%, at least 3%, at least 4%, at least 5%, at least 7.5%, at least 10%, at least 12.5%, at least 15%, at least 17.5%, at least 20%, at least 22.5%, at least 25%, at least 30%, or even at least about 35%. In some embodiments, the thickness of the overall coating at an exterior surface of the nonwoven substrate 102 may be greater than the thickness of the overall coating at the central portion of the nonwoven substrate 102 by not greater than about 50%, such as not greater than 40%, not greater than 35%, not greater than 30%, not greater than 25%, not greater than 22.5%, not greater than 20%, not greater than 17.5%, not greater than 15%, not greater than 12.5%, not greater than 10%, not greater than 7.5%, or even not greater than about 5%. Further, it will be appreciated that the thickness of the overall coating at an exterior surface of the nonwoven substrate 102 may be between any of these minimum and maximum percentages, such as at least about 1% to not greater than about 50%.

Furthermore, in some embodiments, the first coating 206 and/or the second coating 310 may comprise one or more additives. Suitable additives, may include grinding aids, fillers, lubricants, wetting agents, thixotropic materials, surfactants, thickening agents, pigments, dyes, antistatic agents, coupling agents, plasticizers, suspending agents, pH modifiers, adhesion promoters, lubricants, bactericides, fungicides, flame retardants, degassing agents, anti-dusting agents, dual function materials, initiators, chain transfer agents, stabilizers, dispersants, reaction mediators, colorants, and defoamers.

### Antimicrobial Agent

In some embodiments, the nonwoven article 100 may comprise one or more antimicrobial formulations. In some embodiments, the first coating 206 and/or the second coating 310 may comprise one or more antimicrobial formulations. The nonwoven article 100 may have the one or more antimicrobial formulations adhered to, coated, dipped, sprayed, or otherwise disposed on or in the nonwoven article 100 to form an antimicrobial layer over the nonwoven article 100. In some embodiments, the antimicrobial formulation may be configured as a coating that impregnates the nonwoven article and adheres to the fibers of the nonwoven article. Further, the antimicrobial formulation may be applied in any suitable manner that impregnates the nonwoven substrate material in a selective or uniform manner throughout the nonwoven material. In some embodiments, the antimicrobial formulation may be continuous or discontinuous over the nonwoven article 100. In some embodiments, the antimicrobial formulation may comprise at least one antimicrobial agent contained in a matrix material. In some embodiments, the matrix material may be an acrylic material. In some embodiments, the antimicrobial formulation may consist essentially of an acrylic material.

In some embodiments, the nonwoven article 100 may be impregnated with an antimicrobial formulation comprising at least one antimicrobial agent having a broad spectrum and/or a persistent residual antimicrobial effectiveness antimicrobial effectiveness against one or more microbial organisms. In some embodiments, the antimicrobial formulation may comprise at least one antimicrobial agent having a broad spectrum antimicrobial effectiveness and/or a persistent residual antimicrobial effectiveness against one or more microbial organisms and abrasive particles uniformly dispersed in a first polymer composition. In some embodiments, the antimicrobial formulation may have broad spectrum antimicrobial effectiveness and/or persistent residual antimicrobial effectiveness against Staphylococcus aureus (also referred to herein as “S. aureus”), and one or more of Klebsiella pneumonia (also referred to herein as “K. pneumonia”), Bacillus, and Escherichia coli (also referred to herein as “E. coli”).

In some embodiments, the antimicrobial agent may comprise antimicrobial properties as understood by those of ordinary skill in the art, such as the ability to kill (e.g., bactericidal) or inhibit the growth (e.g., bacteriostatic) of microscopic organisms such as, for example, bacteria, fungi, or protozoa. Examples of the first antimicrobial agents may include triclosan (also referred to herein as “TN”), triclocarban (also referred to herein as “TCC”), polyhexamethylene, binguanide (also referred to herein as “PHMB”), salicylic acid, benzalkonium chloride, chloroxylenol, silver, pyrithiones, or any combination thereof. In some embodiments, the antimicrobial agent may include a pyrithione, and more particularly, zinc pyrithione (also referred to herein as “ZPT”). In some embodiments, the first antimicrobial agent may comprise pure silver, elemental silver, ionic silver, or combinations thereof. In an embodiment, the silver may comprise a silver salt. In an embodiment, the silver may be a silver solution, a silver suspension, a silver emulsion, a silver sol, a silver gel, solid silver, a silver powder, a silver composite material, or combinations thereof.

Other examples of the first antimicrobial agents may include bronopol (2-Bromo-2-nitropropane-1,3-diol), chitosan (a hydrophilic polysaccharide derived from chitin), tannic acid, mixtures thereof, blends thereof, or any combination thereof. A the first antimicrobial agent may be available in one or more formats, such as a solution, a suspension, an emulsion, a sol, a gel, a solid, a powder, a composite material, or combinations thereof. In an embodiment, the antimicrobial agent may include a brominated diol and more particularly, 2-Bromo-2-nitropropane-1,3-diol (commonly known as “Bronopol”). In an embodiment, the first antimicrobial agent may comprise chitin, a deacetylated form of chitin, or combinations thereof. In an embodiment, the deacetylated form of chitin may comprise a linear polysaccharide composed of randomly distributed β-linked D-glucosamine and N-acetyl-D-glucosamine. In an embodiment the deacetylated form of chitin comprises chitosan, a co-polymer of (1→4)-2-amine-2-deoxy-β-D-glumay and (1→4)-2-acetamide-2-deoxy-β-D-glumay, or derivatives thereof.

In a particular embodiment, a the first antimicrobial agent may comprise a tannic acid In a particular embodiment, the tannic acid may comprise acidum tannicum, gallotannic acid, digallic acid, gallotannin, tannimum, quercitannin, oak bark tannin, quercotannic acid, quercitannic acid, mixtures thereof, blends thereof, or any combination thereof. In a specific embodiment, the tannic acid may comprise a solution, a suspension, an emulsion, a sol, a gel, a solid, a powder, a composite material, or combinations thereof. In a particular embodiment, the tannic acid may be in combination with a polymer, a polymer composite, or combinations thereof. In a particular embodiment, the antimicrobial agent may comprise bronopol, tannic acid, chitosan, mixtures thereof, blends thereof, or any combination thereof. In a particular embodiment, the antimicrobial agent may consist essentially of bronopol, tannic acid, chitosan, mixtures thereof, blends thereof, or any combination thereof. As used herein, the phrase “consist essentially of,” “consisting essentially of,” “consists essentially of,” or any such an equivalent phrase, limits the scope of the antimicrobial agent to the specified antimicrobial agent, but the scope may include other materials that do not materially affect the characteristic of being an antimicrobial agent as defined herein. In other words, an abrasive article according to an embodiment that consists essentially of bronopol, tannic acid, chitosan, mixtures thereof, blends thereof, or any combination thereof does not include another antimicrobial agent.

The antimicrobial agent may be available in in one or more formats, such as a solution, a suspension, an emulsion, a sol, a gel, a solid, a powder, a composite, or combinations thereof. The antimicrobial agent may be in a suitable particle size, more particularly micro-sized particles, nano-sized particles, or a combination thereof.

In an embodiment, the first antimicrobial agent may have broad spectrum effectiveness against one or more microbial organisms. Broad spectrum antimicrobial effectiveness may be defined as capable of killing at least 75% of the population of an initial inoculation of one or more microbial organisms. Alternatively, broad spectrum effectiveness against one or microbial organisms may be defined as capable of producing a zone of inhibition around a sample of the abrasive article, wherein the zone of inhibition is at least 3 cm for a population of one or more microbial organisms. In a specific embodiment, the first antimicrobial agent may possess broad spectrum antimicrobial effectiveness when it satisfies either of the definitions of broad spectrum effectiveness. In a specific embodiment, the first antimicrobial agent possesses broad spectrum antimicrobial effectiveness when it satisfies both definitions of broad spectrum effectiveness.

Broad spectrum antimicrobial effectiveness may be defined as capable of killing at least 75% of the population of an initial inoculation of E. coli after 24 hours, at least 75% of the population of an initial inoculation of K. pneumoniae after 24 hours, and killing at least 95% of the population of an initial inoculation of S. aureus after 24 hours in accordance with test method ASTM: E2149-10. Broad spectrum antimicrobial effectiveness may be defined as capable of producing a zone of inhibition around a sample of the abrasive article, wherein the zone of inhibition is at least 3 cm for a population of S. aureus, and one or more of K. pneumoniae, Bacillus, and E. coli for a 2.54 cm by 2.54 cm (2.54 cm²) abrasive article sample tested according to the Kirby-Bauer antibiotic testing method (also commonly known as KB testing or disk diffusion antibiotic sensitivity testing. In a specific embodiment, the first antimicrobial agent possesses broad spectrum antimicrobial effectiveness when it satisfies either of the definitions of broad spectrum effectiveness. In a specific embodiment, the first antimicrobial agent possesses broad spectrum antimicrobial effectiveness when it satisfies both definitions of broad spectrum effectiveness.

In an embodiment, the first antimicrobial agent may have a persistent residual antimicrobial effectiveness against one or more microbial organisms. Persistent residual antimicrobial effectiveness may be defined as capable of killing at least about 85%, such as at least 90%, or at least 95%, of the population of an initial inoculation of one or more microbial organisms after seven days. Persistent residual antimicrobial effectiveness may be defined as capable of killing at least about 85%, such as at least 90%, or at least 95%, of the population of an initial inoculation of E. coli after seven days, at least 85%, such as at least 90%, or at least 95%, of the population of an initial inoculation of K. pneumonia after seven days, and at least 95% of the population of an initial inoculation of S. aureus after seven days.

### Antiviral Agent

In some embodiments, the nonwoven article 100 may comprise one or more antiviral formulations. In some embodiments, the first coating 206 and/or the second coating 310 may comprise one or more antiviral formulations. The nonwoven article 100 may have the one or more antiviral formulations adhered to, coated, dipped, sprayed, or otherwise disposed on or in the nonwoven article 100 to form an antiviral layer over the nonwoven article 100. In some embodiments, the antiviral formulation may be configured as a coating that impregnates the nonwoven article and adheres to the fibers of the nonwoven article. Further, the antiviral formulation may be applied in any suitable manner that impregnates the nonwoven substrate material in a selective or uniform manner throughout the nonwoven material. In some embodiments, the antiviral formulation may be continuous or discontinuous over the nonwoven article 100. In some embodiments, the antiviral formulation may comprise at least one antiviral agent contained in a matrix material. In some embodiments, the matrix material may be an acrylic material. In some embodiments, the antiviral formulation may consist essentially of an acrylic material.

In some embodiments, the antiviral agent may include hydroxide, peroxide, ammonium, chlorine-containing compounds, chlorite, chlorate, carbonate, bicarbonate, ethanol, isopropanol, sulfur, lactic acid, dodecylbenzenesulfonic acid, citric acid, octanoic acid, hypochlorous acid, phenolic, dischloroisocyanurate, glutaraldehyde, peroxyacetic acid, peroxymonosulfate, a transition metal element, thymol, dichloro-S-triazinetrione, glycolic acid, triethylene glycol, or a combination thereof. In one embodiment, some more specific examples of antiviral agents may include ammonium carbonate, ammonium bicarbonate, chlorine dioxide, quaternary ammonium, hydrogen peroxide, sodium chlorite, sodium hypochlorite, sodium chlorate, chlorine dioxide, phenolic-containing compounds or derivatives of phenolic, peroxyoctanoic acid, potassium peroxymonosulfate, sodium dischloroisocyanurate, sodium dischloroisocyanurate hydrate, sodium dichloro-S-triazinetrione, copper, silver, silver nanoparticles dispersed in an organic material (e.g., Protec-20) copper nanoparticles dispersed in an organic material, or any combination thereof.

According to some embodiments, the antiviral agent may have a registered disinfectant efficacy against at least one of Group I double-stranded DNA viruses, Group II single-stranded DNA viruses, Group III double-stranded RNA genomes, Group IV positive-sense single-stranded RNA genomes, Group V negative-sense single-stranded RNA genomes, Group VI single-stranded RNA viruses replicating through DNA intermediates, Group VII double-stranded DNA genomes replicating through reverse transcriptase, or any combination thereof. The foregoing is based on the Baltimore classification system. In another embodiment, the antiviral agent may have a registered disinfectant efficacy against any RNA-based viruses. In another non-limiting aspect, the antiviral agent may have a registered disinfectant efficacy against Group IV positive-sense single-stranded RNA genomes. In still another embodiment, the antiviral agent may have a registered disinfectant efficacy against viruses with an enveloped capsid. According to another embodiment, the antiviral agent may have a registered disinfectant efficacy against viruses with a helical capsid symmetry. In still another embodiment, the antiviral agent may have a registered disinfectant efficacy against viruses of the Nidovirales order. For yet another non-limiting embodiment, the antiviral agent may have a registered disinfectant efficacy against viruses of the Coronaviridae family. According to one embodiment, the antiviral agent may have a registered disinfectant efficacy against a virus of the Betacoronavirus genus (e.g., SARS-CoV-2).

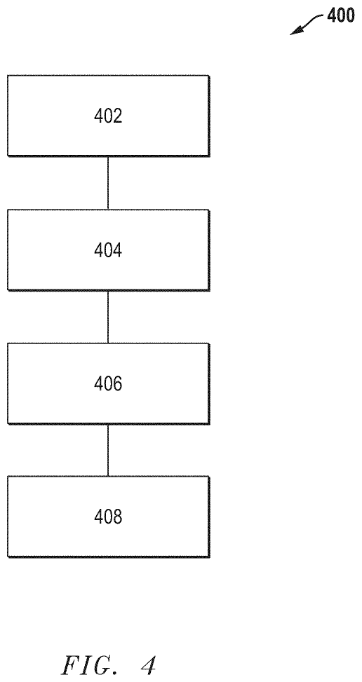

FIG. 4 shows a flowchart of a method 400 of forming a nonwoven article 100, 200, 300 according to an embodiment of the disclosure. Method 400 may begin at block 402 by forming a nonwoven substrate 102 by needle punching a plurality of fibers 104. In some embodiments, needle punching the plurality of fibers 104 may comprise a single needling process. In some embodiments, needle punching the plurality of fibers 104 may comprise a double needling process. Method 400 may continue at block 404 by disposing a first coating 206 onto the nonwoven substrate 102 to form a nonwoven article 200. In particular embodiments, the first coating 206 is applied as a dip coating (i.e., by dipping or submerging the nonwoven substrate 102 in the first coating 206 mixture). Method 400 may continue at block 406 by disposing a second coating 310 onto the nonwoven substrate 102 and at least partially over the first coating 206 to form a nonwoven article 300. In particular embodiments, the second coating 310 is applied as a spray coating (i.e., by spraying the second coating 310 mixture onto the nonwoven substrate 102 and at least partially over the first coating 206). In some embodiments, the first coating 206 may be cured before the second coating 310 is applied. Additionally, in some embodiments, the second coating 310 may be cured prior to additional steps in the method 400. Further, in some embodiments, the method 400 may further comprise disposing one or more antimicrobial formulations and/or antiviral formulations on, in, or a combination thereof, the nonwoven substrate 102 in accordance with embodiments disclosed herein. Optionally, method 400 may continue at block 408 by forming the nonwoven article 300 into a particular shape. Forming may be accomplished by cutting the nonwoven article 300 into any desired shape.

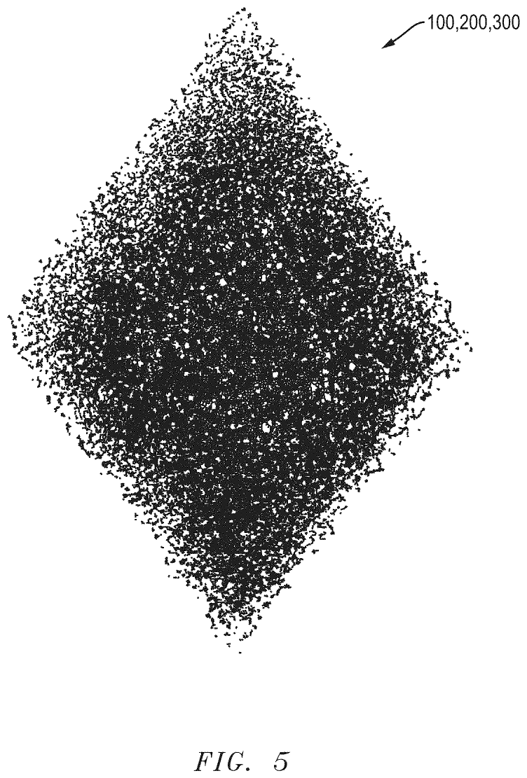

FIG. 5 shows an image of a nonwoven article 100, 200, 300 according to an embodiment of the disclosure. It will be appreciated that the nonwoven article 100, 200, 300 shown in FIG. 5 may be formed by one or more methods disclosed herein.

The nonwoven articles 100, 200, 300 disclosed herein may comprise beneficial and unexpected physical properties including, but not limited to, loft, elongation, tensile strength, stiffness, pore size, permeability, fiber orientation index, or any combination thereof.

Loft

The nonwoven article 100, 200, 300 may comprise a beneficial loft (i.e., thickness). Loft may be measured or quantified as the overall average height (thickness of a profile) of the nonwoven article 100, 200, 300 and/or the nonwoven substrate 102. In some embodiments, the nonwoven article 100, 200, 300 may comprise a loft of at least about 12 millimeters (mm), such as at least 13 mm, at least 14 mm, at least 15 mm, or even at least about 16 mm. In some embodiments, the nonwoven article 100, 200, 300 may comprise a loft of not greater than about 20 mm, such as not greater than 19 mm, not greater than 18 mm, not greater than 17 mm, or even not greater than about 16 mm. Further, it will be appreciated that the nonwoven article 100, 200, 300 may comprise a loft between any of these minimum and maximum values, such as at least about 12 mm to not greater than about 20 mm, or even such as at least about 14 to not greater than 16.

Elongation Percentage

The nonwoven article 100 may comprise a beneficial elongation percentage (i.e., percentage of elongation before breakage and/or separation of fibers 104). Elongation may be measured according to ASTM D5034-09(2017), Standard Test Method for Breaking Strength and Elongation of Textile Fabrics (Grab Test). In some embodiments, the nonwoven article 100 may comprise an elongation percentage of at least about 45%, such as at least 46%, at least 47%, at least 48%, at least 49%, at least 50%, at least 51%, at least 52%, at least 53%, at least 54%, at least 55%, or even at least about 56%. In some embodiments, the nonwoven article 100 may comprise an elongation percentage of not greater than about 90%, such as not greater than 85%, not greater than 80%, not greater then 75%, not greater than 70%, not greater than 65%, not greater than 60%, not greater than 55%, or even not greater than about 50%. Further, it will be appreciated that the nonwoven article 100 may comprise an elongation percentage between any of these minimum and maximum values, such as at least about 45% to not greater than about 90%.

The nonwoven article 200, 300 may comprise a beneficial elongation percentage (i.e., percentage of elongation before breakage and/or separation of fibers 104). Elongation may be measured according to ASTM D5034-09(2017), Standard Test Method for Breaking Strength and Elongation of Textile Fabrics (Grab Test). In some embodiments, the nonwoven article 200, 300 may comprise an elongation percentage of at least about 15%, such as at least 20%, at least 22.5%, or at least about 25%. In some embodiments, the nonwoven article 200, 300 may comprise an elongation percentage of not greater than about 75%, not greater than 50%, not greater than 45%, not greater than 40%, not greater than 35%, or even not greater than about 30%. Further, it will be appreciated that the nonwoven article 200, 300 may comprise an elongation percentage between any of these minimum and maximum values, such as at least about 15% to not greater than about 75%, or even such as at least about 20% to not greater than 30%.

Tensile Strength

The nonwoven article 100 may comprise a beneficial tensile strength. Tensile strength may be measured according to ASTM D5034-09(2017), Standard Test Method for Breaking Strength and Elongation of Textile Fabrics (Grab Test). In some embodiments, the nonwoven article 100 may comprise a tensile strength of at least about 12 kilograms force (kgf), such as at least 13 kgf, at least 14 kgf, at least 15 kgf, at least 16 kgf, at least 17 kgf, at least 18 kgf, at least 19 kgf, at least 20 kgf, or even at least about 21 kgf. In some embodiments, the nonwoven article 100 may comprise a tensile strength of at not greater than about 50 kgf, such as not greater than 45 kgf, not greater than 40 kgf, not greater than 35 kgf, not greater than 30 kgf, or even not greater than 25 kgf. Further, it will be appreciated that the nonwoven article 100 may comprise a tensile strength between any of these minimum and maximum values, such as at least about 12 kgf to not greater than about 50 kgf.

The nonwoven article 200, 300 may comprise a beneficial tensile strength. Tensile strength may be measured according to ASTM D5034-09(2017), Standard Test Method for Breaking Strength and Elongation of Textile Fabrics (Grab Test). In some embodiments, the nonwoven article 200, 300 may comprise a tensile strength of at least about 29 kilograms force (kgf), such as at least 30 kgf, at least 35 kgf, or even at least about 40 kgf. In some embodiments, the nonwoven article 200, 300 may comprise a tensile strength of at not greater than about 60 kgf, such as not greater than 55 kgf, not greater than 50 kgf, or even not greater than 45 kgf. Further, it will be appreciated that the nonwoven article 200, 300 may comprise a tensile strength between any of these minimum and maximum values, such as at least about 29 kgf to not greater than about 60 kgf.

Toughness Index

The nonwoven article 100 may comprise a beneficial toughness index (i.e., elongation percentage/tensile strength), where elongation may be measured according to ASTM D5034—09(2017), Standard Test Method for Breaking Strength and Elongation of Textile Fabrics (Grab Test), and where tensile strength may be measured according to ASTM D5034-09(2017), Standard Test Method for Breaking Strength and Elongation of Textile Fabrics (Grab Test). In some embodiments, the nonwoven article 100 may comprise a toughness index of at least about 1%/kgf, such as at least about 1.2%/kgf, at least 1.4%/kgf, at least 1.6%/kgf, at least 1.8%/kgf, or even at least about 2.0%/kgf. In some embodiments, the nonwoven article 100 may comprise a toughness index not greater than about 4%/kgf, not greater than 3.8%/kgf, not greater than 3.6%/kgf, not greater than 3.4%/kgf, not greater than 3.2%/kgf, or even not greater than about 3.0%/kgf. Further, it will be appreciated that the nonwoven article 100 may comprise a toughness index between any of these minimum and maximum values, such as at least about 2.0%/kgf to not greater than about 4.0%/kgf.

The nonwoven article 200, 300 may comprise a beneficial toughness index (i.e., elongation percentage/tensile strength), where elongation may be measured according to ASTM D5034-09(2017), Standard Test Method for Breaking Strength and Elongation of Textile Fabrics (Grab Test), and where tensile strength may be measured according to ASTM D5034—09(2017), Standard Test Method for Breaking Strength and Elongation of Textile Fabrics (Grab Test). In some embodiments, the nonwoven article 200, 300 may comprise a toughness index of at least about 0.5%/kgf, such as at least about 0.6%/kgf, at least 0.7%/kgf, at least 0.8%/kgf, at least 0.9%/kgf, at least 1.0%/kgf, at least 1.25%/kgf, or even at least about 1.5%/kgf. In some embodiments, the nonwoven article 200, 300 may comprise a toughness index not greater than about 5%/kgf, such as not greater than 4%/kgf, not greater than 3%/kgf, not greater than 2%/kgf, not greater than 1.5%/kgf, or even not greater than about 1.0%/kgf. Further, it will be appreciated that the nonwoven article 200, 300 may comprise a toughness index between any of these minimum and maximum values, such as at least about 0.5%/kgf to not greater than about 5%/kgf, or even such as at least 0.5%/kgf to not greater than 1.0%/kgf.

Stiffness

The nonwoven article 100 may comprise a beneficial stiffness. Bending stiffness may be measured using a Gurley type bending resistance machine according to ASTM D6125-97, Standard Test Method for Bending Resistance of Paper and Paperboard (Gurley Type Tester). In some embodiments, the nonwoven article 100 may comprise a stiffness of at least about 3,500 milligrams (mg), such as at least 4,000 mg, at least 4,500 mg, at least 5,000 mg, at least 5,500 mg, at least 6,000 mg, or even at least about 6,500 mg. In some embodiments, the nonwoven article 100 may comprise a stiffness of not greater than about 10,000 mg, not greater than 9,000 mg, not greater than 8,000 mg, not greater than 7,500 mg, or even not greater than 7,000 mg. Further, it will be appreciated that the nonwoven article 100, 200, 300 may comprise a stiffness between any of these minimum and maximum values, such as at least about 3,500 mg to not greater than about 10,000 mg.

The nonwoven article 200, 300 may comprise a beneficial stiffness. Bending stiffness may be measured using a Gurley type bending resistance machine according to ASTM D6125-97, Standard Test Method for Bending Resistance of Paper and Paperboard (Gurley Type Tester). In some embodiments, the nonwoven article 200, 300 may comprise a stiffness of at least about 50,000 milligrams (mg), such as at least 60,000 mg, at least 70,000 mg, at least 80,000 mg, at least 90,000 mg, at least 100,000 mg, or even at least about 105,000 mg. In some embodiments, the nonwoven article 200, 300 may comprise a stiffness of not greater than about 125,000 mg, not greater than 120,000 mg, or even not greater than 115,000 mg. Further, it will be appreciated that the nonwoven article 200, 300 may comprise a stiffness between any of these minimum and maximum values, such as at least about 50,000 mg to not greater than about 125,000 mg, or even such as at least about 105,000 mg to not greater than 115,000 mg.

Mean Pore Size

The nonwoven article 100 can comprise a beneficial pore size (i.e., mean pore size). The mean pore size may be measured according to ASTM D6767-16, Standard Test Method for Pore Size Characteristics of Geotextiles by Capillary Flow Test. In some embodiments, the nonwoven article 100 may comprise a mean pore size of at least about 130 micrometers (μm), such at least 131 μm, at least 132 μm, at least 134 μm, or even at least about 136 μm. In some embodiments, the nonwoven article 100 may comprise a mean pore size not greater than about 175 micrometers (μm), such as not greater than about 170 μm, not greater than 165 μm, not greater than 150 μm, not greater than 155 μm, not greater than 150 μm, not greater than 145 μm, or even not greater than about 140 μm. Further, it will be appreciated that the nonwoven article 100 may comprise a mean pore size between any of these minimum and maximum values, such as at least about 130 μm to not greater than about 175 μm.

The nonwoven article 200, 300 can comprise a beneficial pore size (i.e., mean pore size). The mean pore size may be measured according to ASTM D6767-16, Standard Test Method for Pore Size Characteristics of Geotextiles by Capillary Flow Test. In some embodiments, the nonwoven article 200, 300 may comprise a mean pore size of at least about 30 micrometers (μm), such at least 50 μm, at least 70 μm, at least 90 μm, at least 110 μm, or even at least about 115 μm. In some embodiments, the nonwoven article 200, 300 may comprise a mean pore size not greater than about 300 micrometers (μm), such as not greater than about 200 μm, not greater than 150 μm, not greater than 140 μm, or even not greater than about 135 μm. Further, it will be appreciated that the nonwoven article 200, 300 may comprise a mean pore size between any of these minimum and maximum values, such as at least about 50 μm to not greater than about 300 μm, or even such as at least about 115 μm to not greater than 135 μm.

Permeability

The nonwoven article 100 can comprise a beneficial permeability. The air permeability may be measured according to ASTM D737, Standard Test Method for Air Permeability of Textile Fabrics. In some embodiments, the nonwoven article 100 may comprise a permeability of at least about 14 ft³/min/ft², such as at least 15 ft³/min/ft², or even at least about 16 ft³/min/ft². In some embodiments, the nonwoven article 100 may comprise a permeability of not greater than about 20 ft³/min/ft², such as not greater than 19 ft³/min/ft², not greater than 18 ft³/min/ft², or even not greater than about 17 ft³/min/ft². Further, it will be appreciated that the nonwoven article 100, 200, 300 may comprise a permeability between any of these minimum and maximum values, such as at least about 14 ft³/min/ft² to not greater than about 20 ft³/min/ft².

The nonwoven article 200, 300 can comprise a beneficial permeability. The air permeability may be measured according to ASTM D737, Standard Test Method for Air Permeability of Textile Fabrics. In some embodiments, the nonwoven article 200, 300 may comprise a permeability of at least about 11 ft³/min/ft², such as at least 12 ft³/min/ft², or even at least about 13 ft³/min/ft². In some embodiments, the nonwoven article 200, 300 may comprise a permeability of not greater than about 20 ft³/min/ft², such as not greater than 19 ft³/min/ft², not greater than 18 ft³/min/ft², not greater than 17 ft³/min/ft², or even not greater than about 16 ft³/min/ft². Further, it will be appreciated that the nonwoven article 200, 300 may comprise a permeability between any of these minimum and maximum values, such as at least about 11 ft³/min/ft² to not greater than about 20 ft³/min/ft², or even such as at least about 13 ft³/min/ft² to not greater than about 16 ft³/min/ft².

MD/CD Fiber Orientation Factor/Index

The nonwoven article 100 can comprise a beneficial MD/CD Fiber Orientation Factor/Index. To measure the MD/CD Fiber Orientation Factor/Index, a nonwoven substrate 102 may be placed into an orientation analyzing device, which analyzes the orientation of the fibers 104 according to the frequency of the fiber position angle relative to the machine direction (MD) and the cross direction (CD) according to NWSP 407.0.R1 (12), Standard Test for Fiber Orientation Distribution of Nonwoven Fabrics.. A mean value of the angle, a standard deviation, and a ratio between the MD Orientation Factor/CD Orientation Factor are calculated and presented as an Orientation Factor/Index. In some embodiments, the nonwoven article 100 may comprise an Orientation Factor/Index of at least about 0.8, at least 0.9, at least 1.0, at least 1.1, at least 1.2, at least 1.3, at least 1.4, at least 1.5, at least 1.6, at least 1.7, at least 1.8, at least 1.9, or even at least about 2.0. In some embodiments, the nonwoven article 100 may comprise an Orientation Index of not greater than 3.0, such as not greater than 2.5, not greater than 2.4, not greater than 2.3, or even not greater than 2.2. Further, it will be appreciated that the nonwoven article 100 may comprise an Orientation Index between any of these minimum and maximum values, such as at least about 0.8 to not greater than about 3.0.

The nonwoven article 200, 300 can comprise a beneficial MD/CD Fiber Orientation Factor/Index. To measure the MD/CD Fiber Orientation Factor/Index, a nonwoven substrate 102 may be placed into an orientation analyzing device, which analyzes the orientation of the fibers 104 according to the frequency of the fiber position angle relative to the machine direction (MD) and the cross direction (CD) according to NWSP 407.0.R1 (12), Fiber Orientation Distribution of Nonwoven Fabrics. A mean value of the angle, a standard deviation, and a ratio between the MD Orientation Factor/CD Orientation Factor are calculated and presented as an Orientation Index. In some embodiments, the nonwoven article 200, 300 may comprise an Orientation Factor of at least about 1.0, such as at least 1.05, at least 1.10, at least 1.15, at least 1.20, at least 1.25, at least 1.30, or even at least about 1.35. In some embodiments, the nonwoven article 200, 300 may comprise an Orientation Index of not greater than 2.5, such as not greater than 2.4, not greater than 2.3, not greater than 2.2, not greater than 2.1, not greater than 2.0, not greater than 1.9, not greater than 1.8, not greater than 1.7, not greater than 1.6, not greater than 1.5, or even not greater than about 1.4. Further, it will be appreciated that the nonwoven article 200, 300 may comprise an Orientation Index between any of these minimum and maximum values, such as at least about 1.0 to not greater than about 2.5, or even such as at least about 1.0 to not greater than 1.4.

MD Orientation Factor

In some embodiments, the nonwoven article 100, 200, 300 may comprise an MD Orientation Factor of at least about 1.0, such as at least 1.02, at least 1.04, at least 1.06, at least 1.08, at least 1.10, at least 1.12, at least 1.14, at least 1.16, or even at least about 1.18. In some embodiments, the nonwoven article 100, 200, 300 may comprise an MD Orientation Factor of not greater than 2.0, such as not greater than 1.5, not greater than 1.25, not greater than 1.24, not greater than 1.23, or even not greater than about 1.22. Further, it will be appreciated that the nonwoven article 100, 200, 300 may comprise an MD Orientation Factor between any of these minimum and maximum values, such as at least about 1.0 to not greater than about 1.5, or even such as at least about 1.18 to not greater than 1.22.

CD Orientation Factor

In some embodiments, the nonwoven article 100, 200, 300 may comprise a CD Orientation Factor of at least about 0.5, such as at least 0.6, at least 0.7, at least about 0.8, at least 0.85, or even at least about 0.88. In some embodiments, the nonwoven article 100, 200, 300 may comprise a CD Orientation Factor of not greater than 1.5, such as not greater than 1.25, not greater than 1.2, not greater than 1.1, not greater than 1.0, or even not greater than about 0.9. Further, it will be appreciated that the nonwoven article 100, 200, 300 may comprise a CD Orientation Factor between any of these minimum and maximum values, such as at least about 0.5 to not greater than about 1.5, or even such as at least about 0.8 to not greater than 0.9.

### EXAMPLES

An exemplary embodiment (“S1”) of a nonwoven article 100, 200, 300 was formed by methods of this disclosure using a double needling process to form the nonwoven substrate 102 from a blend of a plurality of fibers 104. A control nonwoven article (“C1”) was also formed using a double needling process to form their respective nonwoven substrates from a blend of a plurality of fibers.

The sample (S1) and control nonwoven article (C1) were produced according to the following coating and curing process. A first polymeric abrasive composition precursor was disposed onto and throughout a nonwoven substrate by dipping the nonwoven substrate into the first polymeric abrasive composition precursor. The first abrasive composition precursor comprised 33-34 wt. % of aluminum oxide #240-280 grit abrasive particles dispersed in a phenolic resin composition as described below in Table 1.

TABLE 1
Dip Coating

| Component | Wt. % |
|---|---|
| Al₂O₃ | 33-34 |
| Resole PF resin | 47-48 |
| Water | Remainder |

The first abrasive composition precursor was well dispersed on and throughout the web of fibers. The coated nonwoven web was then passed through an oven, curing the dip coating to form a cured first abrasive composition disposed on the nonwoven web of fibers.

Next, a second polymeric abrasive composition precursor was disposed onto the nonwoven web by spraying a first major surface and opposing second major surface of the nonwoven web with the second polymeric abrasive composition precursor. The second polymeric abrasive composition precursor comprised 57-58 wt. % of #240-280 grit aluminum oxide abrasive particles dispersed in a phenolic resin composition as described below in Table 2.

TABLE 2
Spray Coating

| Component | Wt. % |
|---|---|
| Al₂O₃ | 57-58 |
| Resole PF resin | 22-23 |
| Water | Remainder |

The sample and control coated webs were then passed through an oven, curing the spray coating and forming a completed nonwoven abrasive article. The exemplary embodiment of a nonwoven article, S1, was compared to the control nonwoven article, C1, and tested for structural and physical properties, which are described in Table 3. The nonwoven abrasive sheet materials were then converted (i.e., cut) into handheld size nonwoven abrasive scrubbers having various shapes: rectangular shape, a pentagonal shape, and a diamond shape for abrasive performance testing. Surprisingly and beneficially, the exemplary embodiment (S1) of the nonwoven article 100, 200, 300 achieved improved performance characteristics as compared to the control nonwoven article (C1). The results are shown in the table below.

TABLE 3

| | S1 | C1 |
|---|---|---|
| Needling | double | double |
| Backing GSM (fiber + latex) | 455-495 | 455-495 |
| Dip coating | dip | dip |
| Spray coating | spray | spray |
| Loft(mm) | 14-16 | 11-12 |
| Elongation % | 25 | 14 |
| Tensile strength (kgf) | 41 | 28 |
| Stiffness(mg) | 108,000-112,000 | 48600 |
| Mean pore size (μm) | 116-132 | 279 |
| Permeability (ft³/min/ft²) | 13-15 | 15 |
| Machine Direction (MD) | 1.18-1.22 | 1.22 |
| Orientation Factor | | |
| Cross Direction (CD) | 0.88 | 1.25 |
| Orientation Factor | | |
| MD/CD Orientation Index | 1.36 | 0.975 |
| Needling parameters | | |
| Needling board 1 - | 80-85 | 75 |
| stroke(rev/cm²) | | |
| Needle depth board 1 | 3.4-11.0 | 3.4 |
| into substrate (mm) | | |
| Needling board 2 - | 95-120 | 110 |
| stroke (rev/cm²) | | |
| Needle depth board 2 | 3.2-10.12 | 4 |
| into substrate (mm) | | |

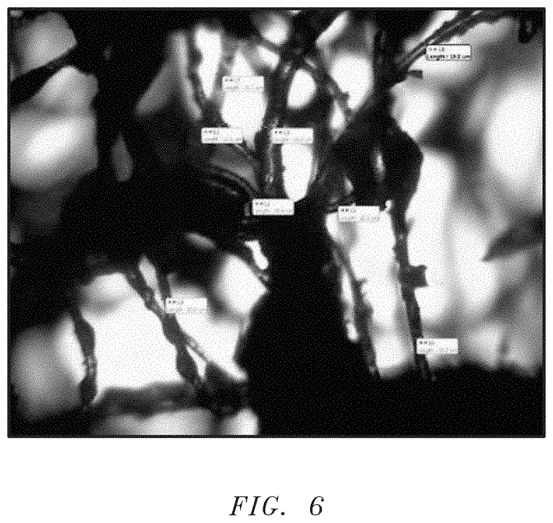

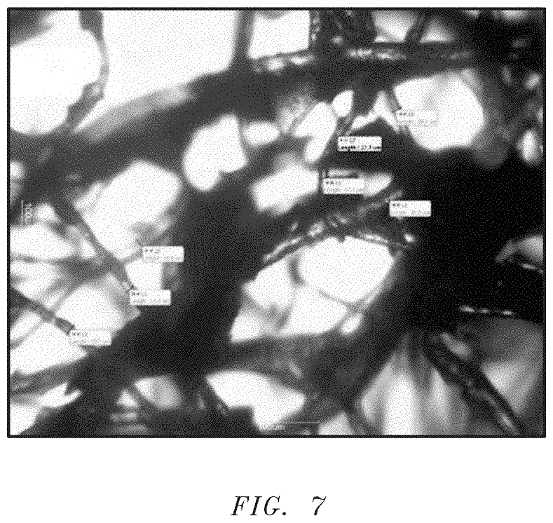

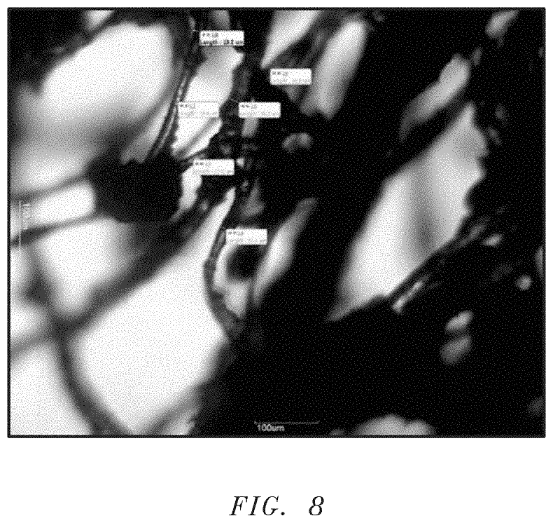

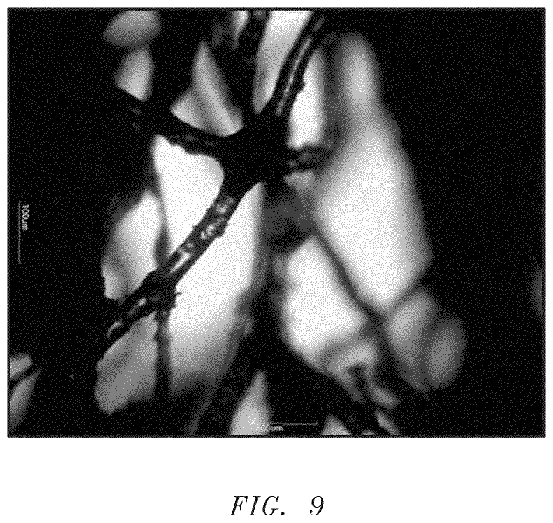

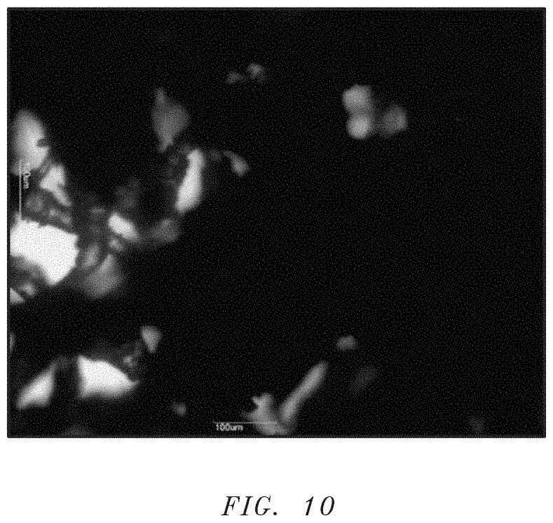

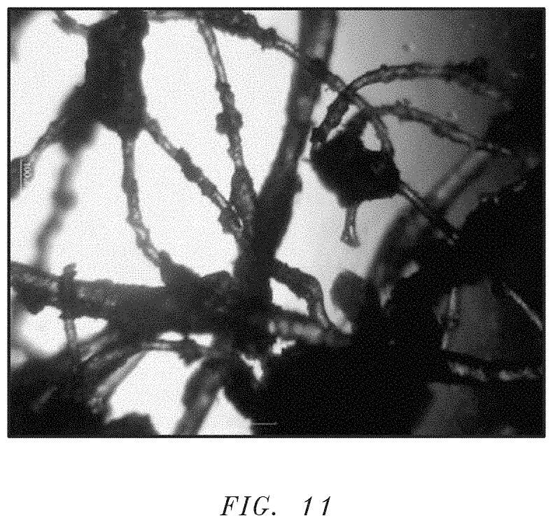

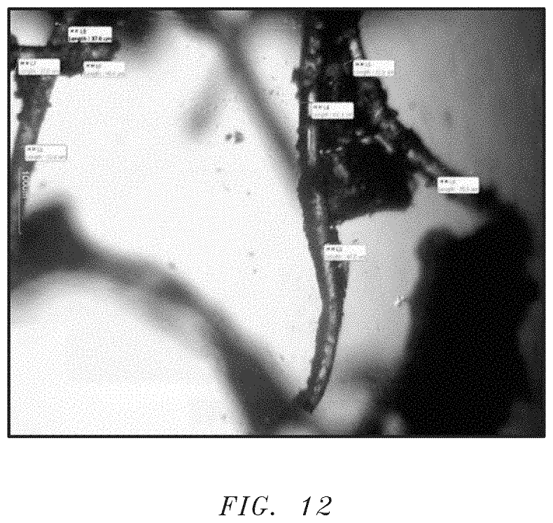

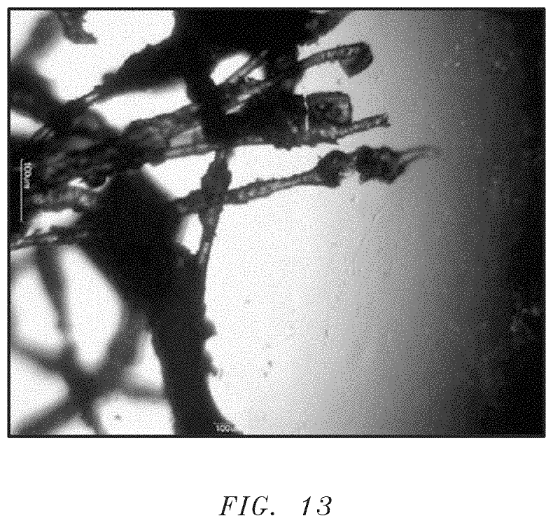

FIGS. 6 through 9 show microscopic images of a top (FIGS. 6 and 7) and a side (FIGS. 8 and 9) of an exemplary embodiment (e.g., S1) of a nonwoven article 100, 200, 300 according to an embodiment of the disclosure. FIGS. 10 through 13 show microscopic images of a top (FIGS. 10 and 11) and a side (FIGS. 12 and 13) of a control nonwoven article (e.g., C1). Most notably, the control nonwoven articles exhibit a larger percentage of broken fibers.

In some embodiments, breakage of the fibers in a nonwoven article 100, 200, 300 may be at least about 1% less than the breakage in the control nonwoven articles, at least about 2%, at least about 3%, at least about 4%, at least about 5%, such as at least 10%, at least 15%, at least 20%, at least 25%, at least 30%, at least 35%, at least 40%, at least 45%, at least 50%, at least 55% as at least 60%, at least 65%, at least 70%, at least 75%, at least 80%, at least 85%, at least 90%, or even at least 95%. In some embodiments, breakage of the fibers in a nonwoven article 100, 200, 300 may be not greater than about 95% less than the breakage in the control nonwoven articles, such as not greater than 90%, not greater than 85%, not greater than 80%, not greater than 75%, not greater than 70%, not greater than 65%, not greater than 60%, not greater than 55%, not greater than 50%, not greater than 45%, not greater than 40%, not greater than 35%, not greater than 30%, not greater than 25%, not greater than 20%, not greater than 15%, or even not greater than 10%. Further, it will be appreciated that breakage of the fibers in a nonwoven article 100, 200, 300 may be between any of these minimum and maximum percentages, such as at least about 1% less than the breakage in the control nonwoven articles to not greater than about 95% less than the breakage in the control nonwoven articles.

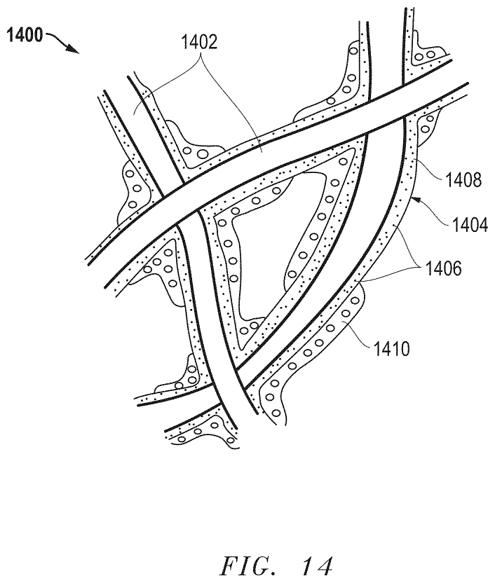

FIG. 14 shows is an oblique close-up view of a portion of a nonwoven article 1400 according to an embodiment of the disclosure. The nonwoven article 1400 comprises a substrate 1402, which may be substantially similar to nonwoven substrate 102, comprising a lofty, open web of fibers. In some embodiments, the substrate 1402 may be at least partially coated by an antimicrobial or antiviral layer 1404. In some embodiments, the antimicrobial or antiviral layer 1404 may includes an antimicrobial or antiviral agent 1406 contained in a matrix material 1408. The antimicrobial or antiviral layer 1404 may be either a continuous or a discontinuous layer. In some embodiments, the antimicrobial or antiviral agent 1406 may be homogenously distributed throughout the volume of matrix material 1408. In some embodiments, the antimicrobial or antiviral layer 1404 may be applied over any one of the nonwoven articles 100, 200, 300 contemplated by this disclosure.

In a particular embodiment, the antimicrobial or antiviral layer 1404 may be applied via roller coating. Specifically, the substrate 1402 may be passed between two or more rollers that are coated with an antimicrobial or antiviral layer 1404 including the antimicrobial or antiviral agent 1406 contained in a matrix material 1408 to uniformly coat the substrate 1402. In a particular embodiment, the antimicrobial or antiviral layer 1404 may be deposited directly onto the substrate 1402 without an intervening layer disposed between the antimicrobial or antiviral layer 1404 and the substrate 1402.

In some embodiments, the antimicrobial or antiviral agent 1406 may comprise an average particle size (D50av) of not greater than 900 nm or not greater than 800 nm or not greater than 700 nm or not greater than 600 nm or not greater than 500 nm or not greater than 400 nm or not greater than 300 nm or not greater than 200 nm or not greater than 100 nm or not greater than 90 nm or not greater than 70 nm or not greater than 50 nm. In some embodiments, the antimicrobial or antiviral agent 1406 may comprise an average particle size (D50av) of at least 0.1 nm or at least 0.5 nm or at least 1 nm or at least 2 nm or at least 3 nm or at least 5 nm or at least 10 nm.

In some embodiments, the antimicrobial or antiviral agent 1406 may comprise an average thickness of (Tav) and that is not greater than 50(D50av), not greater than 40(D50av), or not greater than 30(D50av), or not greater than 20(D50av), or not greater than 15(D50av), or not greater than 10(D50av), or not greater than 8(D50av), or not greater than 6(D50av), or not greater than 5(D50av), or not greater than 4 (D50av). In some embodiments, Tav may be at least 1(D50av), at least 1.2(D50av), at least 1.5(D50av), at least 2(D50av), at least 3(D50av), at least 5(D50av).

In an embodiment the antimicrobial or antiviral agent 1406 is present in an amount of at least 0.1 wt. % for a total weight of the antiviral layer, or at least 0.5 wt. %, at least 0.8 wt. %, at least 1 wt. %, at least 1.2 wt. %, at least 1.5 wt. %, at least 2 wt. %, at least 4 wt. %, or at least 6 wt. %. In another embodiment the antimicrobial or antiviral agent 1406 is present in an amount of not greater than 25 wt. % for a total weight of the antiviral layer, or not greater than 20 wt. %, not greater than 15 wt. %, not greater than 12 wt. %, not greater than 10 wt. %, not greater than 8 wt. %, not greater than 5 wt. %, or not greater than 4 wt. %.

In an embodiment, the matrix material 1408 includes a binder. The binder can be an organic material like those used in a binder layer (e.g., make coat or size coat) as described in any of the embodiments herein. In a particular embodiment, the matrix material 1408 includes a thermoset polymer. Preferably, the matrix material 1408 includes or consists of an acrylic.

In an embodiment the antimicrobial or antiviral agent 1406 may overly at least 50% of the total surface area of the nonwoven fibers, or at least 60%, or at least 70%, or at least 80%, or at least 90%, or at least 95%, or at least 99%. In another embodiment, the antimicrobial or antiviral agent 1406 may overly not greater than 99% or the total surface area of the nonwoven fibers or not greater than 98%, or not greater than 97%, or not greater than 96%, or not greater than 95%, or not greater than 93%, or not greater than 90%, or not greater than 80%.

In an embodiment, the substrate 1402 is coated with an abrasive layer 1410 (collectively, the first coating 206 and the second coting 310), such that the abrasive layer 1410 at least partially overlies the antimicrobial or antiviral layer 1404. The abrasive layer 1410 may be applied using any known coating techniques in accordance with embodiments disclosed herein. The abrasive layer 1410 may be applied as a continuous layer, or a discontinuous layer including regions of coating separated by gaps regions that are absent the abrasive layer 1410, such that the antimicrobial or antiviral layer 1404 is at least partially exposed. In certain embodiments, the abrasive layer 1410 may be in direct contact with the antimicrobial or antiviral layer 1404 and is separated from the substrate 1402 in certain regions by the antimicrobial or antiviral layer 1404. In a preferred embodiment, the abrasive layer 1410 is applied as a discontinuous abrasive layer in order to maintain and/or control the exposure of the underlying antimicrobial or antiviral layer 1404. Notably, the process balances the thickness of the antimicrobial or antiviral layer 1404, coating % of the antimicrobial or antiviral layer 1404, thickness of the abrasive layer 1410, and coating % of the abrasive layer 1410 to create a product that has a select combination of abrasive capability and antimicrobial or antiviral capability.

In some embodiments, the abrasive layer 1410 overlies at least 5% of the total surface area of the substrate and/or antiviral layer or at least 10% or at least 15% or at least 20% or at least 25% or at least 30% or at least 35% or at least 40% or at least 45% or at least 50% or at least 55% or at least 60% or at least 65% or at least 70% or at least 75% or at least 80% or at least 85% or at least 90% or at least 95%. In some embodiments, the abrasive layer 1410 overlies not greater than 99% or the total surface area of the substrate and/or antiviral layer or not greater than 90% or not greater than 85% or not greater than 80% or not greater than 75% or not greater than 70% or not greater than 65% or not greater than 60% or not greater than 55% or not greater than 50% or not greater than 45% or not greater than 40% or not greater than 35% or not greater than 30% or not greater than 25% or not greater than 20% or not greater than 15% or not greater than 10%.

In an embodiment, the abrasive particles in the abrasive layer 1410 may comprise an average particle size (D50ab) that is greater than D50av. In particular embodiments, D50ab/Dav is greater than 1 or at least 1.5 or at least 2 or at least 3 or at least 5 or least 10 or at least 25. In other embodiments D50ab/Dav is not greater than 1000 or not greater than 800 or not greater than 500 or not greater than 300 or not greater than 200 or not greater than 100 or not greater than 80 or not greater than 60 or not greater than 40 or not greater than 20.

In certain embodiments, the antimicrobial or antiviral layer 1404 covers a percentage of the surface area of the substrate 1402 of (Cav), and the abrasive layer 1410 covers a percentage of the of the surface area of the substrate of (Cab), and Cav/Cab is greater than 1 or at least 1.2 or least 1.5 or at least 1.8 or at least 2 or at least 3 or at least 4 or at least 5 or at least 6 or at least 8 or at least 10.

An exemplary embodiment (“S2”) of a nonwoven article 1400 was formed by methods of this disclosure and at least partially coated by an antimicrobial or antiviral layer 1404. S2 included zinc pyrithione (ZPT) as the antimicrobial or antiviral agent 1406. A control nonwoven article (“C2”) was also formed. C2 did not include an antimicrobial or antiviral agent. However, it is known that some binders can have antiviral efficacy. S2 and C2 were administered to surfaces which were infected with Escherichia Coli (E. Coli), Klebsiella Pneumonia (K. pneumonia), Staphylococcus Aureus (S. Aureus), Adeno-associated Viruses (AAV), and Herpes Simplex Type 1 Virus (HSV-1).

C2 exhibited no reduction in Escherichia Coli (E. Coli), Klebsiella Pneumonia (K. pneumonia), and Staphylococcus Aureus (S. Aureus) microbial organisms. C2 inoculated 99.00% of the Adeno-associated Viruses (AAV) and Herpes Simplex Type 1 Virus (HSV-1) viruses. This results in C2 having an antiviral activity rating per ISO 18184 of 2.0 for the Adeno-associated Viruses (AAV) and an antiviral activity rating per ISO 18184 of 1.4 for the Herpes Simplex Type 1 Virus (HSV-1)

S2 inoculated 99.88% of each of the Escherichia Coli (E. Coli), Klebsiella Pneumonia (K. pneumonia), and Staphylococcus Aureus (S. Aureus) microbial organisms. S2 also inoculated 99.99% of the Adeno-associated Viruses (AAV) and Herpes Simplex Type 1 Virus (HSV-1) viruses. This results in S2 an antiviral activity rating per ISO 18184 of 3.0 for the Adeno-associated Viruses (AAV) and an antiviral activity rating per ISO 18184 of 2.7 Herpes Simplex Type 1 Virus (HSV-1). Accordingly, S2 has shown an increased inoculation of Escherichia Coli (E. Coli), Klebsiella Pneumonia (K. pneumonia), Staphylococcus Aureus (S. Aureus), Adeno-associated Viruses (AAV), and Herpes Simplex Type 1 Virus (HSV-1). The results are shown in the table below:

TABLE 4

| | E. Coli | K. Pneumonia | S. Aureus | AAV | HSV-1 |
|---|---|---|---|---|---|
| Control | No reduction | No reduction | No reduction | 99.00% | 99.00% |
| (C2) | | | | | |
| Sample | 99.88% | 99.88% | 99.88% | 99.99% | 99.99% |
| (S2) | | | | | |
| (2 wt. | | | | | |
| % ZPT) | | | | | |

In embodiments contemplated by this disclosure, a nonwoven article may include one or more of the following items:

### Embodiment 1

A nonwoven article, comprising: a nonwoven substrate comprising a lofty, open web of fibers; and a coating overlying the nonwoven substrate, the coating having a greater thickness at an exterior surface of the nonwoven substrate as compared to a central region of the nonwoven substrate spaced apart from the exterior surface.

### Embodiment 2

The nonwoven article of Embodiment 1, wherein the thickness of the coating at the exterior surface of the nonwoven substrate is greater than the thickness of the coating at the central portion of the nonwoven substrate by at least about 1%, as at least 2%, at least 3%, at least 4%, at least 5%, at least 7.5%, at least 10%, at least 12.5%, at least 15%, at least 17.5%, at least 20%, at least 22.5%, at least 25%, at least 30%, or at least about 35%.

### Embodiment 3

The nonwoven article of Embodiment 2, wherein the thickness of the coating at the exterior surface of the nonwoven substrate is greater than the thickness of the coating at the central portion of the nonwoven substrate by not greater than about 50%, not greater than 40%, not greater than 35%, not greater than 30%, not greater than 25%, not greater than 22.5%, not greater than 20%, not greater than 17.5%, not greater than 15%, not greater than 12.5%, not greater than 10%, not greater than 7.5%, or not greater than about 5%.

### Embodiment 4

The nonwoven article of Embodiment 1, wherein the nonwoven substrate comprises a single monolithic substrate.

### Embodiment 5

A nonwoven article, comprising: a nonwoven substrate comprising a lofty, open web of fibers; and a coating overlying the nonwoven substrate; wherein the nonwoven article comprises a stiffness of at least 50,000 milligrams.

### Embodiment 6

A nonwoven article, comprising: a nonwoven substrate comprising a lofty, open web of fibers; and a coating overlying the nonwoven substrate; wherein the nonwoven article comprises a toughness index (elongation percentage/tensile strength) of at least 0.5%/kgf.

### Embodiment 7

A nonwoven article, comprising: a nonwoven substrate comprising a lofty, open web of fibers; and a coating overlying the nonwoven substrate; wherein the nonwoven article comprises a toughness index (elongation percentage/tensile strength) of at least 0.5%/kgf, stiffness of at least 50,000 mg and an Elongation of at least 15%.

### Embodiment 8

A nonwoven article, comprising: a nonwoven substrate comprising a lofty, open web of fibers; and a coating overlying the nonwoven substrate; wherein the nonwoven substrate comprises a loft of at least 14 mm, an Orientation Index of at least 1.0, and a mean pore size of at least 30 microns.

### Embodiment 9

The nonwoven article of any of Embodiments 1 to 7, wherein the nonwoven article comprises a loft of at least 12 millimeters (mm), at least 13 mm, at least 14 mm, or at least about 15 mm.

### Embodiment 10

The nonwoven article of any of Embodiments 1 to 9, wherein the nonwoven article comprises a loft of not greater than 20 mm, not greater than 19 mm, not greater than 18 mm, not greater than 17 mm, or not greater than 16 mm.

### Embodiment 11

The nonwoven article of any of Embodiments 1 to 10, wherein the nonwoven article comprises an elongation percentage of at least 15%, at least 20%, or at least 25%.

### Embodiment 12

The nonwoven article of any of Embodiments 1 to 11, wherein the nonwoven article comprises an elongation percentage of not greater than 75%, not greater than 70%, not greater than 65%, not greater then 60%, not greater than 55%, not greater than 50%, not greater than 45%, not greater than 40%, or not greater than 30%.

### Embodiment 13

The nonwoven article of any of Embodiments 1 to 12, wherein the nonwoven article comprises a tensile strength of at least 29 kilograms force (kgf), at least 30 kgf, at least 35 kgf, or at least 40 kgf.

### Embodiment 14

The nonwoven article of any of Embodiments 1 to 13, wherein the nonwoven article comprises a tensile strength of at not greater than 60 kgf, not greater than 55 kgf, not greater than 50 kgf, or not greater than 45 kgf.

### Embodiment 15

The nonwoven article of any of Embodiments 1 to 14, wherein the nonwoven article comprises a toughness index (elongation percentage/tensile strength) of at least 0.5%/kgf, at least 0.6%/kgf, at least 0.7%/kgf, at least 0.8%/kgf, at least 0.9%/kgf, at least 1.0%/kgf, at least 1.25%/kgf, or at least 1.5%/kgf.

### Embodiment 16

The nonwoven article of any of Embodiments 1 to 15, wherein the nonwoven article 100, 200, 300 comprises a toughness index (elongation percentage/tensile strength) of not greater than 5%/kgf, not greater than 4%/kgf, not greater than 3%/kgf, not greater than 2%/kgf, not greater than 1.5%/kgf, or not greater than 1.0%/kgf/mm.

### Embodiment 17

The nonwoven article of any of Embodiments 1 to 16, wherein the nonwoven article comprises a stiffness of at least 50,000 milligrams (mg), at least 60,000 mg, at least 70,000 mg, at least 80,000 mg, at least 90,000 mg, at least 100,000 mg, or at least 105,000 mg.

### Embodiment 18

The nonwoven article of any of Embodiments 1 to 17, wherein the nonwoven article comprises a stiffness of not greater than 125,000 mg, not greater than 120,000 mg, or not greater than 115,000 mg.

### Embodiment 19

The nonwoven article of any of Embodiments 1 to 18, wherein the nonwoven article comprises a mean pore size of at least 50 micrometers (μm), such at least 70 μm, at least 90 μm, at least 110 μm, or at least 115 μm.

### Embodiment 20

The nonwoven article of any of Embodiments 1 to 19, wherein the nonwoven article 100, 200, 300 comprises a mean pore size not greater than 300 micrometers (μm), not greater than 200 μm, not greater than 150 μm, not greater than 140 μm, or not greater than 135 μm.

### Embodiment 21

The nonwoven article of any of Embodiments 1 to 20, wherein the nonwoven article comprises a permeability of at least 11 ft³/min/ft², such as at least 12 ft³/min/ft², or at least 13 ft³/min/ft².

### Embodiment 22

The nonwoven article of any of Embodiments 1 to 21, wherein the nonwoven article comprises a permeability of not greater than 20 ft³/min/ft², such as not greater than 19 ft³/min/ft², not greater than 18 ft³/min/ft², not greater than 17 ft³/min/ft², or not greater than 16 ft³/min/ft².

### Embodiment 23

The nonwoven article of any of Embodiments 1 to 22, wherein the nonwoven article comprises an MD Orientation Factor of at least 1.0, such as at least 1.02, at least 1.04, at least 1.06, at least 1.08, at least 1.10, at least 1.12, at least 1.14, at least 1.16, or at least 1.18.

### Embodiment 24

The nonwoven article of any of Embodiments 1 to 23, wherein the nonwoven article comprises an MD Orientation Factor of not greater than 2.0, such as not greater than 1.5, not greater than 1.25, not greater than 1.24, not greater than 1.23, or not greater than 1.22.

### Embodiment 25

The nonwoven article of any of Embodiments 1 to 24, wherein the nonwoven substrate comprises a blend of a plurality of fibers comprising a first type of fibers and a second type of fibers, and wherein the first type of fibers is different from the second type of fibers in composition, construction, denier, length, ratio, shape, thickness, type, or any combination thereof.

### Embodiment 26

The nonwoven article of Embodiment 25, wherein a denier of the first type of fibers is different from a denier of the second type of fibers by at least about 5%, at least 10%, at least 15%, at least 20%, at least 25%, at least 30%, at least 35%, at least 40%, at least 45%, at least 50%, at least 55% as at least 60%, at least 65%, at least 70%, at least 75%, at least 80%, at least 85%, at least 90%, at least 95%, at least 100%, at least 150%, at least 200%, at least 300%, at least 400%, at least 500%, at least about 1000%, or at least 2000%.

### Embodiment 27

The nonwoven article of Embodiment 26, wherein a denier of the first type of fibers is different from a denier of the second type of fibers by not greater than 2000%, not greater than 1000%, not greater than 500%, not greater than 400%, not greater than 300%, not greater than 200%, not greater than 100%, not greater than 95% of the plurality of fibers 104, such as not greater than 90%, not greater than 85%, not greater than 80%, not greater than 75%, not greater than 70%, not greater than 65%, not greater than 60%, not greater than 55%, not greater than 50%, not greater than 45%, not greater than 40%, not greater than 35%, not greater than 30%, not greater than 25%, not greater than 20%, not greater than 15%, not greater than 10%, or not greater than about 5%.

### Embodiment 28

The nonwoven article of any of Embodiments 25 to 27, wherein the plurality of fibers comprises: 5 to 95% of the first type of fibers; and 5 to 95% of the second type of fibers.

### Embodiment 29

The nonwoven article of any of Embodiments 1 to 28, wherein the nonwoven substrate is formed by a double needling process.

### Embodiment 30

The nonwoven article of Embodiment 29, wherein the nonwoven substrate comprises a single monolithic substrate.

### Embodiment 31

The nonwoven article of any of Embodiments 1 to 4 or 9 to 30, wherein the coating comprises a first coating and a second coating.

### Embodiment 32

The nonwoven article of Embodiment 31, wherein the first coating comprises a dip coating and the second coating comprises a spray coating.

### Embodiment 33

The nonwoven article of Embodiment 32, wherein at least one of the first coating and the second coating comprises abrasive particles disposed in a polymeric binder composition.

### Embodiment 34

The nonwoven article of any of Embodiments 1 to 33, further comprising: an antimicrobial formulation, an antiviral formulation, or a combination thereof disposed on, in, or a combination thereof, the nonwoven substrate.

### Embodiment 35

The nonwoven article of Embodiment 34, wherein the antimicrobial formulation or the antiviral formulation comprises an antimicrobial agent or antiviral agent and abrasive particles uniformly dispersed in a first polymer composition.

### Embodiment 36

The nonwoven article of Embodiment 34, wherein the antimicrobial or antiviral formulation comprises: 0.1 wt. % to 5.0 wt. % of the antimicrobial agent or antiviral agent; 20 wt. % to 70 wt. % of abrasive particles; and 10 wt. % to 60 wt. % of a first polymer composition.

### Embodiment 37

The nonwoven article of Embodiment 36, wherein the antimicrobial agent comprises triclosan, triclocarban, polyhexamethylene biguanide, zinc pyrithione, salicylic acid, benzalkonium chloride, chloroxylenol, silver, bronopol, tannic acid, chitosan, or any combination thereof.

### Embodiment 38

The nonwoven article of Embodiment 37, wherein the antimicrobial formulation comprises a broad spectrum antimicrobial effectiveness against one or more microbial organisms defined as capable of killing at least about 75% of the population of an initial inoculation of one or more microbial organisms after 24 hours.

### Embodiment 39

The nonwoven article of Embodiment 37, wherein the antimicrobial formulation comprises a broad spectrum antimicrobial against one or more microbial organisms defined as capable of killing at least about 75% of the population of an initial inoculation of E. coli after 24 hours, at least 75% of the population of an initial inoculation of K. pneumonia after 24 hours, and killing at least 95% of the population of an initial inoculation of S. aureus after 24 hours.

### Embodiment 40

The nonwoven article of Embodiment 37, wherein the nonwoven article comprises a persistent residual antimicrobial against one or more microbial organisms effectiveness defined as capable of killing at least about 85% of the population of an initial inoculation of one or more microbial organisms after seven days.

### Embodiment 41

The nonwoven article of Embodiment 37, wherein the nonwoven article comprises a persistent residual antimicrobial effectiveness against one or more microbial organisms defined as capable of killing at least about 85% of the population of an initial inoculation of E. coli after seven days, at least 85% of the population of an initial inoculation of K. pneumonia after seven days, and at least 95% of the population of an initial inoculation of S. aureus after seven days.

### Embodiment 42

The nonwoven article of Embodiment 36, wherein the antiviral agent comprises hydroxide, peroxide, ammonium, chlorine-containing compounds, chlorite, chlorate, carbonate, bicarbonate, ethanol, isopropanol, sulfur, lactic acid, dodecylbenzenesulfonic acid, citric acid, octanoic acid, hypochlorous acid, phenolic, dischloroisocyanurate, glutaraldehyde, peroxyacetic acid, peroxymonosulfate, a transition metal element, thymol, dichloro-S-triazinetrione, glycolic acid, triethylene glycol, or a combination thereof.

### Embodiment 43

The nonwoven article of Embodiment 42, wherein the antiviral formulation comprises a registered disinfectant efficacy against at least one of Group I double-stranded DNA viruses, Group II single-stranded DNA viruses, Group III double-stranded RNA genomes, Group IV positive-sense single-stranded RNA genomes, Group V negative-sense single-stranded RNA genomes, Group VI single-stranded RNA viruses replicating through DNA intermediates, Group VII double-stranded DNA genomes replicating through reverse transcriptase, or any combination thereof.

### Embodiment 44

The nonwoven article of Embodiment 42, wherein the antiviral formulation comprises a registered disinfectant efficacy against any RNA-based viruses.

### Embodiment 45

The nonwoven article of Embodiment 42, wherein the antiviral formulation comprises a registered disinfectant efficacy against Group IV positive-sense single-stranded RNA genomes.

### Embodiment 46

The nonwoven article of Embodiment 42, wherein the antiviral formulation comprises a registered disinfectant efficacy against viruses with an enveloped capsid.

### Embodiment 47

The nonwoven article of Embodiment 42, wherein the antiviral formulation comprises a registered disinfectant efficacy against viruses with a helical capsid symmetry.

### Embodiment 48

The nonwoven article of Embodiment 42, wherein the antiviral formulation comprises a registered disinfectant efficacy against viruses of the Nidovirales order.

### Embodiment 49

The nonwoven article of Embodiment 42, wherein the antiviral formulation comprises a registered disinfectant efficacy against viruses of the Coronaviridae family.

### Embodiment 50

The nonwoven article of Embodiment 42, wherein the antiviral formulation comprises a registered disinfectant efficacy against a virus of the Betacoronavirus genus.

### Embodiment 51

A method of forming a nonwoven article, comprising: coating a nonwoven substrate having an orientation index of at least 1, wherein coating comprises: dip coating the nonwoven substrate; and spray coating at least a portion of the nonwoven substrate after dip coating; wherein the nonwoven substrate comprises at least one of: 1) the coating having a greater thickness at an exterior surface of the nonwoven substrate as compared to a central region of the nonwoven substrate spaced apart from the exterior surface; 2) an elongation of at least 1518%; 3) a tensile strength of at least 29 kilograms force (kgf); 4) a toughness index of at least 0.51%/kgf; 5) a stiffness of at least 50,000 milligrams; or 6) any combination thereof.

### Embodiment 52

The method of Embodiment 51, further comprising: double needling the nonwoven substrate prior to coating at least partially entangle a plurality of fibers that form the nonwoven substrate.

### Embodiment 53

The method of any of Embodiments 51 to 52, further comprising: disposing at least one of an antimicrobial formulation and an antiviral formulation on, in, or a combination thereof, the nonwoven substrate.

### Embodiment 54

A nonwoven article, comprising: a nonwoven substrate comprising a lofty, open web of fibers; and an antimicrobial formulation, an antiviral formulation, or a combination thereof disposed on, in, or a combination thereof, the nonwoven substrate.

### Embodiment 55

The nonwoven article of Embodiment 54, wherein the antimicrobial formulation or the antiviral formulation comprises an antimicrobial agent or antiviral agent and abrasive particles uniformly dispersed in a first polymer composition.

### Embodiment 56

The nonwoven article of Embodiment 54, wherein the antimicrobial or antiviral formulation comprises: 0.1 wt. % to 5.0 wt. % of the antimicrobial agent or antiviral agent; 20 wt. % to 70 wt. % of abrasive particles; and 10 wt. % to 60 wt. % of a first polymer composition.

### Embodiment 57

The nonwoven article of Embodiment 56, wherein the antimicrobial agent comprises triclosan, triclocarban, polyhexamethylene biguanide, zinc pyrithione, salicylic acid, benzalkonium chloride, chloroxylenol, silver, bronopol, tannic acid, chitosan, or any combination thereof.

### Embodiment 58

The nonwoven article of Embodiment 57, wherein the antimicrobial formulation comprises a broad spectrum antimicrobial effectiveness against one or more microbial organisms defined as capable of killing at least about 75% of the population of an initial inoculation of one or more microbial organisms after 24 hours.

### Embodiment 59

The nonwoven article of Embodiment 57, wherein the antimicrobial formulation comprises a broad spectrum antimicrobial against one or more microbial organisms defined as capable of killing at least about 75% of the population of an initial inoculation of E. coli after 24 hours, at least 75% of the population of an initial inoculation of K. pneumonia after 24 hours, and killing at least 95% of the population of an initial inoculation of S. aureus after 24 hours.

### Embodiment 60

The nonwoven article of Embodiment 57, wherein the nonwoven article comprises a persistent residual antimicrobial against one or more microbial organisms effectiveness defined as capable of killing at least about 85% of the population of an initial inoculation of one or more microbial organisms after seven days.

### Embodiment 61

The nonwoven article of Embodiment 57, wherein the nonwoven article comprises a persistent residual antimicrobial effectiveness against one or more microbial organisms defined as capable of killing at least about 85% of the population of an initial inoculation of E. coli after seven days, at least 85% of the population of an initial inoculation of K. pneumonia after seven days, and at least 95% of the population of an initial inoculation of S. aureus after seven days.

### Embodiment 62

The nonwoven article of Embodiment 56, wherein the antiviral agent comprises hydroxide, peroxide, ammonium, chlorine-containing compounds, chlorite, chlorate, carbonate, bicarbonate, ethanol, isopropanol, sulfur, lactic acid, dodecylbenzenesulfonic acid, citric acid, octanoic acid, hypochlorous acid, phenolic, dischloroisocyanurate, glutaraldehyde, peroxyacetic acid, peroxymonosulfate, a transition metal element, thymol, dichloro-S-triazinetrione, glycolic acid, triethylene glycol, or a combination thereof.

### Embodiment 63

The nonwoven article of Embodiment 62, wherein the antiviral formulation comprises a registered disinfectant efficacy against at least one of Group I double-stranded DNA viruses, Group II single-stranded DNA viruses, Group III double-stranded RNA genomes, Group IV positive-sense single-stranded RNA genomes, Group V negative-sense single-stranded RNA genomes, Group VI single-stranded RNA viruses replicating through DNA intermediates, Group VII double-stranded DNA genomes replicating through reverse transcriptase, or any combination thereof.

### Embodiment 64

The nonwoven article of Embodiment 62, wherein the antiviral formulation comprises a registered disinfectant efficacy against any RNA-based viruses.

### Embodiment 65

The nonwoven article of Embodiment 62, wherein the antiviral formulation comprises a registered disinfectant efficacy against Group IV positive-sense single-stranded RNA genomes.

### Embodiment 66

The nonwoven article of Embodiment 62, wherein the antiviral formulation comprises a registered disinfectant efficacy against viruses with an enveloped capsid.

### Embodiment 67

The nonwoven article of Embodiment 62, wherein the antiviral formulation comprises a registered disinfectant efficacy against viruses with a helical capsid symmetry.

### Embodiment 68

The nonwoven article of Embodiment 62, wherein the antiviral formulation comprises a registered disinfectant efficacy against viruses of the Nidovirales order.

### Embodiment 69

The nonwoven article of Embodiment 62, wherein the antiviral formulation comprises a registered disinfectant efficacy against viruses of the Coronaviridae family.

### Embodiment 70

The nonwoven article of Embodiment 62, wherein the antiviral formulation comprises a registered disinfectant efficacy against a virus of the Betacoronavirus genus.

### Embodiment 71

The nonwoven article of Embodiment 54, wherein the antimicrobial formulation or the antiviral formulation is a discontinuous layer on the nonwoven substrate.

### Embodiment 72

The nonwoven article of Embodiment 54, wherein the antimicrobial formulation or the antiviral formulation is a continuous layer overlying the nonwoven substrate.

### Embodiment 73

The nonwoven article of Embodiment 54, wherein the antimicrobial formulation or the antiviral formulation is in direct contact with the nonwoven substrate without an intervening layer disposed between the antimicrobial formulation or the antiviral formulation and the nonwoven substrate.

### Embodiment 74

The nonwoven article of Embodiment 54, wherein the antimicrobial formulation or the antiviral formulation is overlying at least 50% of the total surface area of the nonwoven substrate or at least 60%, or at least 70%, or at least 80%, or at least 90%, or at least 95%, or at least 99%.

### Embodiment 75

The nonwoven article of Embodiment 54, wherein the antimicrobial formulation or the antiviral formulation is overlying not greater than 99% or the total surface area of the nonwoven substrate or not greater than 98% or not greater than 97% or not greater than 96% or not greater than 95% or not greater than 90% or not greater than 80%.

### Embodiment 76

The nonwoven article of Embodiment 54, wherein the antimicrobial formulation or the antiviral formulation comprises an antimicrobial or antiviral agent contained in a matrix material.

### Embodiment 77

The nonwoven article of Embodiment 76, wherein the antimicrobial or antiviral agent comprises an average particle size (D50) of not greater than 900 nm or not greater than 800 nm or not greater than 700 nm or not greater than 600 nm or not greater than 500 nm or not greater than 400 nm or not greater than 300 nm or not greater than 200 nm or not greater than 100 nm or not greater than 90 nm or not greater than 70 nm or not greater than 50 nm.

### Embodiment 78

The nonwoven article of Embodiment 77, wherein the antimicrobial or antiviral agent comprises an average particle size (D50) or at least 0.1 nm or at least 0.5 nm or at least 1 nm or at least 2 nm or at least 3 nm or at least 5 nm or at least 10 nm.

### Embodiment 79

The nonwoven article of Embodiment 76, wherein the antimicrobial or antiviral agent is present in an amount of at least 0.1 wt. % for a total weight of the antiviral layer or at least 0.5 wt. % or at least 0.8 wt. % or at least 1 wt. % or at least 1.2 wt. % or at least 1.5 wt. % or at least 2 wt. % or at least 4 wt. % or at least 6 wt. %.

### Embodiment 80

The nonwoven article of Embodiment 79, wherein the antimicrobial or antiviral agent is present in an amount of not greater than 25 wt. % for a total weight of the antiviral layer or not greater than 20 wt. % or not greater than 15 wt. % or not greater than 12 wt. % or not greater than 10 wt. % or not greater than 8 wt. % or not greater than 5 wt. % or not greater than 4 wt. %.

### Embodiment 81

The nonwoven article of Embodiment 76, wherein the antimicrobial or antiviral agent is homogenously distributed throughout the volume of matrix material.

### Embodiment 82

The nonwoven article of Embodiment 76, wherein the matrix material comprises a binder.

### Embodiment 83

The nonwoven article of Embodiment 76, wherein the matrix material comprises an organic material like those used in a binder layer (e.g., make coat or size coat) as described in any of the embodiments herein.

### Embodiment 84

The nonwoven article of Embodiment 76, wherein the matrix material comprises a thermoset polymer.

### Embodiment 85

The nonwoven article of Embodiment 76, wherein the matrix material comprises an acrylic.

### Embodiment 86

The nonwoven article of Embodiment 76, wherein the matrix material consists essentially of acrylic.

### Embodiment 87

The nonwoven article of Embodiment 54, wherein the abrasive layer is a continuous layer overlying the nonwoven substrate.

### Embodiment 88

The nonwoven article of Embodiment 54, further comprising: an abrasive layer in direct contact with the antiviral layer and is separated from the non-woven fibers in certain regions by the antimicrobial formulation or the antiviral formulation.

### Embodiment 89

The nonwoven article of Embodiment 88, wherein the abrasive layer is overlying at least 5% of the total surface area of the nonwoven substrate and/or antimicrobial formulation or the antiviral formulation or at least 10% or at least 15% or at least 20% or at least 25% or at least 30% or at least 35% or at least 40% or at least 45% or at least 50% or at least 55% or at least 60% or at least 65% or at least 70% or at least 75% or at least 80% or at least 85% or at least 90% or at least 95%.

### Embodiment 90

The nonwoven article of Embodiment 89, wherein the abrasive layer is overlying not greater than 99% or the total surface area of the nonwoven substrate and/or the antimicrobial formulation or the antiviral formulation or not greater than 90% or not greater than 85% or not greater than 80% or not greater than 75% or not greater than 70% or not greater than 65% or not greater than 60% or not greater than 55% or not greater than 50% or not greater than 45% or not greater than 40% or not greater than 35% or not greater than 30% or not greater than 25% or not greater than 20% or not greater than 15% or not greater than 10%.

### Embodiment 91

The nonwoven article of Embodiment 54, wherein the antimicrobial formulation or the antiviral formulation comprises an average thickness of (Tav) and wherein Tav is not greater than 50(D50avp), wherein D50avp represents the average particles size of the antimicrobial or the antiviral agent in the antiviral layer, or wherein Tav is not greater than 40(D50avp) or not greater than 30(D50avp) or not greater than 20(D50avp) or not greater than 15(D50avp) or not greater than 10(D50avp) or not greater than 8(D50avp) or not greater than 6(D50avp) or not greater than 5(D50avp) or not greater than 4 (D50avp).

### Embodiment 92

The nonwoven article of Embodiment 54, wherein the antimicrobial formulation or the antiviral formulation comprises an average thickness of (Tav) and wherein Tav is at least 1(D50avp), wherein D50avp represents the average particles size of the antimicrobial or the antiviral agent in the antimicrobial formulation or the antiviral formulation, or wherein Tav is at least 1.2(D50avp) or at least 1.5(D50avp) at least 2(D50avp) at least 3(D50avp) at least 5(D50avp).

### Embodiment 93

The nonwoven article of Embodiment 88, wherein abrasive particles in the abrasive layer comprise an average particle size (D50ab), and the antimicrobial formulation or the antiviral formulation comprises an antimicrobial or antiviral agent having an average particle size (D50avp), wherein D50ab>D50avp.

### Embodiment 94

The nonwoven article of Embodiment 93, wherein D50ab/Davp is greater than 1 or at least 1.5 or at least 2 or at least 3 or at least 5 or least 10 or at least 25.

### Embodiment 95

The nonwoven article of Embodiment 94, wherein D50ab/Davp is not greater than 1000 or not greater than 800 or not greater than 500 or not greater than 300 or not greater than 200 or not greater than 100 or not greater than 80 or not greater than 60 or not greater than 40 or not greater than 20.

### Embodiment 96

The nonwoven article of Embodiment 88, wherein the antimicrobial formulation or the antiviral formulation comprises a percent coverage of the surface of the nonwoven substrate of (Cav) and the abrasive layer comprises a percent coverage of the surface of the substrate of (Cab), and wherein Cav/Cab is greater than 1 or at least 1.2 or least 1.5 or at least 1.8 or at least 2 or at least 3 or at least 4 or at least 5 or at least 6 or at least 8 or at least 10.

### Embodiment 97

A nonwoven article, comprising: a lofty, open web of fibers having an Orientation Index of at least 1 and a tensile strength of at least 12 kgf.

### Embodiment 98

A nonwoven article, comprising: a lofty, open web of fibers having an Orientation Index of at least 1 and a stiffness of at least 3500 milligrams.

### Embodiment 99

A nonwoven article, comprising: a lofty, open web of fibers having a loft of at least 13, an Orientation Index of at least 1, and a toughness index (elongation percentage/tensile strength) of at least 1.0%/kgf and not greater than 4%/kgf.

### Embodiment 100

The nonwoven article of any of Embodiments 1 to 3, wherein the nonwoven article comprises a loft of at least 13 millimeters (mm), at least 14 mm, at least 15 mm, or at least 16 mm.

### Embodiment 101

The nonwoven article of any of Embodiments 97, 98, or 100, wherein the nonwoven article comprises a loft of not greater than 20 mm, not greater than 19 mm, not greater than 18 mm, not greater than 17 mm, or not greater than 16 mm.

### Embodiment 102

The nonwoven article of any of Embodiments 97 to 101, wherein the Orientation Index is at least 1.1 or at least 1.2 or at least 1.3 or at least 1.4 or at least 1.5 or at least 1.6 or at least 1.7 or at least 1.8 or at least 1.9 or at least 2.0 or at least 2.1 or at least 2.2.

### Embodiment 103

The nonwoven article of any of Embodiments 97 to 102, wherein the Orientation Index is not greater than 10 or not greater than 9 or not greater than 8 or not greater than 7 or not greater than 6 or not greater than 5 or not greater than 4 or not greater than 3 or not greater than 2.8 or not greater than 2.5.

### Embodiment 104

The nonwoven article of any of Embodiments 97 to 103, wherein the nonwoven article comprises an elongation percentage of at least 45%, at least 46%, at least 47%, at least 48%, or at least 49%.

### Embodiment 105

The nonwoven article of any of Embodiments 97 to 104, wherein the nonwoven article comprises an elongation percentage of not greater than 90%, not greater than 85%, not greater than 80%, not greater then 75%, not greater than 70%, not greater than 65%, not greater than 60%, not greater than 55%, or not greater than 50%.

### Embodiment 106

The nonwoven article of any of Embodiments 97 to 105, wherein the nonwoven article comprises a tensile strength of at least 12 kilograms force (kgf), at least 13 kgf, at least 14 kgf, at least 15 kgf, at least 16 kgf, at least 17 kgf, at least 18 kgf, at least 19 kgf, at least 20 kgf, or at least 21 kgf.

### Embodiment 107

The nonwoven article of any of Embodiments 97 to 106, wherein the nonwoven article comprises a tensile strength of at not greater than 50 kgf, not greater than 45 kgf, not greater than 40 kgf, not greater than 35 kgf, not greater than 34 kgf, not greater than 33 kgf, or not greater than 32 kgf.

### Embodiment 108

The nonwoven article of any of Embodiments 97 to 107, wherein the nonwoven article comprises a toughness index (elongation percentage/tensile strength) of 1%/kgf, at least 1.2%/kgf, at least 1.4%/kgf, at least 1.6%/kgf, at least 1.8%/kgf, or at least 2.0%/kgf.

### Embodiment 109

The nonwoven article of any of Embodiments 97 to 108, wherein the nonwoven article 100, 200, 300 may comprise a toughness index (elongation percentage/tensile strength) of not greater than 4%/kgf, not greater than 3.8%/kgf, not greater than 3.6%/kgf, not greater than 3.4%/kgf, not greater than 3.2%/kgf, or not greater than 3.0%/kgf.

### Embodiment 110

The nonwoven article of any of Embodiments 97 to 109, wherein the nonwoven article comprises a stiffness of at least 3,500 milligrams (mg), at least 4,000 mg, at least 4,500 mg, at least 5,000 mg, at least 5,500 mg, at least 6,000 mg, or at least 6,500 mg.

### Embodiment 111

The nonwoven article of any of Embodiments 97 to 110, wherein the nonwoven article comprises a stiffness of not greater than 10,000 mg, not greater than 9,000 mg, not greater than 8,000 mg, not greater than 7,500 mg, or not greater than 7,000 mg

### Embodiment 112

The nonwoven article of any of Embodiments 97 to 111, wherein the nonwoven article comprises a mean pore size of at least 130 micrometers (μm), at least 131 μm, at least 132 μm, at least 134 μm, or at least 136 μm.

### Embodiment 113

The nonwoven article of any of Embodiments 97 to 112, wherein the nonwoven article comprises a mean pore size of not greater than 175 micrometers (μm), not greater than about 170 μm, not greater than 165 μm, not greater than 150 μm, not greater than 155 μm, not greater than 150 μm, not greater than 145 μm, or not greater than 140 μm.

### Embodiment 114

The nonwoven article of any of Embodiments 97 to 113, wherein the nonwoven article comprises a permeability of at least 14 ft³/min/ft², at least 15 ft³/min/ft², or at least 16 ft³/min/ft².

### Embodiment 115

The nonwoven article of any of Embodiments 97 to 114, wherein the nonwoven article comprises a permeability of not greater than 20 ft³/min/ft², such as not greater than 19 ft³/min/ft², not greater than 18 ft³/min/ft², or not greater than 17 ft³/min/ft².

### Embodiment 116

The nonwoven article of any of Embodiments 97 to 115, wherein the nonwoven article comprises a blend of a plurality of fibers comprising a first type of fibers and a second type of fibers, and wherein the first type of fibers is different from the second type of fibers in composition, construction, denier, length, ratio, shape, thickness, type, or any combination thereof.

### Embodiment 117

The nonwoven article of Embodiment 116, wherein a denier of the first type of fibers is different from a denier of the second type of fibers by at least about 5%, at least 10%, at least 15%, at least 20%, at least 25%, at least 30%, at least 35%, at least 40%, at least 45%, at least 50%, at least 55% as at least 60%, at least 65%, at least 70%, at least 75%, at least 80%, at least 85%, at least 90%, at least 95%, at least 100%, at least 150%, at least 200%, at least 300%, at least 400%, at least 500%, at least about 1000%, or at least 2000%.

### Embodiment 118

The nonwoven article of Embodiment 117, wherein a denier of the first type of fibers is different from a denier of the second type of fibers by not greater than 2000%, not greater than 1000%, not greater than 500%, not greater than 400%, not greater than 300%, not greater than 200%, not greater than 100%, not greater than 95% of the plurality of fibers 104, such as not greater than 90%, not greater than 85%, not greater than 80%, not greater than 75%, not greater than 70%, not greater than 65%, not greater than 60%, not greater than 55%, not greater than 50%, not greater than 45%, not greater than 40%, not greater than 35%, not greater than 30%, not greater than 25%, not greater than 20%, not greater than 15%, not greater than 10%, or not greater than about 5%.

### Embodiment 119

The nonwoven article of any of Embodiments 116 to 118, wherein the plurality of fibers comprises: 5 to 95% of the first type of fibers; and 5 to 95% of the second type of fibers.

### Embodiment 120

The nonwoven article of any of Embodiments 97 to 119, wherein the nonwoven article is formed by a double needling process.

### Embodiment 121

The nonwoven article of Embodiment 120, wherein the nonwoven article comprises a single monolithic substrate.

### Embodiment 122

The nonwoven article of any of Embodiments 97 to 121, further comprising: an antimicrobial formulation, an antiviral formulation, or a combination thereof disposed on, in, or a combination thereof, the lofty, open web of fibers within the lofty, open web of fibers.

### Embodiment 123

The nonwoven article of Embodiment 122, wherein the antimicrobial formulation or the antiviral formulation comprises an antimicrobial agent or antiviral agent and abrasive particles uniformly dispersed in a first polymer composition.

### Embodiment 124

The nonwoven article of Embodiment 26, wherein the antimicrobial or antiviral formulation comprises: 0.1 wt. % to 5.0 wt. % of the antimicrobial agent or antiviral agent; 20 wt. % to 70 wt. % of abrasive particles; and 10 wt. % to 60 wt. % of a first polymer composition.

### Embodiment 125

The nonwoven article of Embodiment 124, wherein the antimicrobial agent comprises triclosan, triclocarban, polyhexamethylene biguanide, zinc pyrithione, salicylic acid, benzalkonium chloride, chloroxylenol, silver, bronopol, tannic acid, chitosan, or any combination thereof.

### Embodiment 126

The nonwoven article of Embodiment 125, wherein the antimicrobial formulation comprises a broad spectrum antimicrobial effectiveness against one or more microbial organisms defined as capable of killing at least about 75% of the population of an initial inoculation of one or more microbial organisms after 24 hours.

### Embodiment 127

The nonwoven article of Embodiment 125, wherein the antimicrobial formulation comprises a broad spectrum antimicrobial against one or more microbial organisms defined as capable of killing at least about 75% of the population of an initial inoculation of E. coli after 24 hours, at least 75% of the population of an initial inoculation of K. pneumonia after 24 hours, and killing at least 95% of the population of an initial inoculation of S. aureus after 24 hours.

### Embodiment 128

The nonwoven article of Embodiment 125, wherein the nonwoven article comprises a persistent residual antimicrobial against one or more microbial organisms effectiveness defined as capable of killing at least about 85% of the population of an initial inoculation of one or more microbial organisms after seven days.

### Embodiment 129

The nonwoven article of Embodiment 125, wherein the nonwoven article comprises a persistent residual antimicrobial effectiveness against one or more microbial organisms defined as capable of killing at least about 85% of the population of an initial inoculation of E. coli after seven days, at least 85% of the population of an initial inoculation of K. pneumonia after seven days, and at least 95% of the population of an initial inoculation of S. aureus after seven days.

### Embodiment 130

The nonwoven article of Embodiment 124, wherein the antiviral agent comprises hydroxide, peroxide, ammonium, chlorine-containing compounds, chlorite, chlorate, carbonate, bicarbonate, ethanol, isopropanol, sulfur, lactic acid, dodecylbenzenesulfonic acid, citric acid, octanoic acid, hypochlorous acid, phenolic, dischloroisocyanurate, glutaraldehyde, peroxyacetic acid, peroxymonosulfate, a transition metal element, thymol, dichloro-S-triazinetrione, glycolic acid, triethylene glycol, or a combination thereof.

### Embodiment 131

The nonwoven article of Embodiment 130, wherein the antiviral formulation comprises a registered disinfectant efficacy against at least one of Group I double-stranded DNA viruses, Group II single-stranded DNA viruses, Group III double-stranded RNA genomes, Group IV positive-sense single-stranded RNA genomes, Group V negative-sense single-stranded RNA genomes, Group VI single-stranded RNA viruses replicating through DNA intermediates, Group VII double-stranded DNA genomes replicating through reverse transcriptase, or any combination thereof.

### Embodiment 132

The nonwoven article of Embodiment 130, wherein the antiviral formulation comprises a registered disinfectant efficacy against any RNA-based viruses.

### Embodiment 133

The nonwoven article of Embodiment 130, wherein the antiviral formulation comprises a registered disinfectant efficacy against Group IV positive-sense single-stranded RNA genomes.

### Embodiment 134

The nonwoven article of Embodiment 130, wherein the antiviral formulation comprises a registered disinfectant efficacy against viruses with an enveloped capsid.

### Embodiment 135

The nonwoven article of Embodiment 130, wherein the antiviral formulation comprises a registered disinfectant efficacy against viruses with a helical capsid symmetry.

### Embodiment 136

The nonwoven article of Embodiment 130, wherein the antiviral formulation comprises a registered disinfectant efficacy against viruses of the Nidovirales order.

### Embodiment 137

The nonwoven article of Embodiment 130, wherein the antiviral formulation comprises a registered disinfectant efficacy against viruses of the Coronaviridae family.

### Embodiment 138

The nonwoven article of Embodiment 130, wherein the antiviral formulation comprises a registered disinfectant efficacy against a virus of the Betacoronavirus genus.

### Embodiment 139

A method of forming a nonwoven article, comprising: needle punching a plurality of fibers via a double needling process to form a nonwoven substrate having an orientation index of at least 1, wherein double needling process comprises: needle punching the plurality of fibers with a first needling board, wherein the first needling board comprises a needling stroke of at least 75 revolutions/square centimeter (rev/cm²) and a needling depth of at least 3.4 millimeters (mm); and needle punching the plurality of fibers with a second needling board, wherein the second needling board comprises a needling stroke that is higher than the needling stroke of the first needling board and a needling depth that is less that the needling depth of the second needling board; wherein the nonwoven substrate comprises a loft of at least 13 millimeters, an Orientation Index of at least 1, and at least one of: 1) a tensile strength of at least 12 kilograms force (kgf); 2) a toughness index (elongation percentage/tensile strength) of at least 1.0%/kgf and not greater than 4%/kgf; 3) stiffness of at least 3500 milligrams; or 4) any combination thereof.

### Embodiment 140

The method of Embodiment 139, wherein the second needling stroke is at least about 90 revolutions/square centimeter (rev/cm²), such as at least 100 rev/cm², at least 105 rev/cm², at least 110 rev/cm², at least 115 rev/cm², at least 116 rev/cm², at least 117 rev/cm², at least 118 rev/cm², at least 119 rev/cm², or at least about 120 rev/cm².

### Embodiment 141

The method of Embodiment 139 or 140, wherein the second needling depth is at least about 1.0 millimeters (mm), such as at least 1.5 mm, at least 2.0 mm, at least 2.5 mm, at least 3.0 mm, at least 3.1 mm, at least 3.2 mm, at least 3.3 mm, at least 3.4 mm, at least 3.5 mm, at least 3.6 mm, at least 3.8 mm, at least 4.0 mm, at least 4.2 mm, at least 4.4 mm, at least 4.6 mm, at least 4.8 mm, at least 5.0 mm, at least 5.2 mm, at least 5.4 mm, at least 5.6 mm, at least 5.8 mm, at least 6.0 mm, at least 6.2 mm, at least 6.4 mm, at least 6.6 mm, at least 6.8 mm, at least 7.0 mm, at least 7.2 mm, at least 7.4 mm, at least 7.6 mm, at least 7.8 mm, at least 8.0 mm, at least 8.2 mm, at least 8.4 mm, at least 8.6 mm, at least 8.8 mm, at least 9.0 mm, at least 9.2 mm, at least 9.4 mm, at least 9.6 mm, at least 9.8 mm, at least 9.0 mm, at least 9.2 mm, at least 9.4 mm, at least 9.6 mm, at least 9.8 mm, or at least about 10.0 mm.

### Embodiment 142

The method of any of Embodiments 139 to 141, further comprising: disposing at least one of an antimicrobial formulation and an antiviral formulation on, in, or a combination thereof, the nonwoven substrate.

### Embodiment 143

A nonwoven article, comprising: a nonwoven substrate comprising a lofty, open web of fibers; and an antimicrobial formulation or antiviral formulation disposed on, in, or a combination thereof the nonwoven substrate.

### Embodiment 144

The nonwoven article of Embodiment 143, wherein the antimicrobial formulation or the antiviral formulation comprises an antimicrobial agent or antiviral agent and abrasive particles uniformly dispersed in a first polymer composition.

### Embodiment 145

The nonwoven article of Embodiment 143, wherein the antimicrobial or antiviral formulation comprises: 0.1 wt. % to 5.0 wt. % of the antimicrobial agent or antiviral agent; 20 wt. % to 70 wt. % of abrasive particles; and 10 wt. % to 60 wt. % of a first polymer composition.

### Embodiment 146

The nonwoven article of Embodiment 145, wherein the antimicrobial agent comprises triclosan, triclocarban, polyhexamethylene biguanide, zinc pyrithione, salicylic acid, benzalkonium chloride, chloroxylenol, silver, bronopol, tannic acid, chitosan, or any combination thereof.

### Embodiment 147

The nonwoven article of Embodiment 146, wherein the antimicrobial formulation comprises a broad spectrum antimicrobial effectiveness against one or more microbial organisms defined as capable of killing at least about 75% of the population of an initial inoculation of one or more microbial organisms after 24 hours.

### Embodiment 148

The nonwoven article of Embodiment 146, wherein the antimicrobial formulation comprises a broad spectrum antimicrobial against one or more microbial organisms defined as capable of killing at least about 75% of the population of an initial inoculation of E. coli after 24 hours, at least 75% of the population of an initial inoculation of K. pneumonia after 24 hours, and killing at least 95% of the population of an initial inoculation of S. aureus after 24 hours.

### Embodiment 149

The nonwoven article of Embodiment 146, wherein the nonwoven article comprises a persistent residual antimicrobial against one or more microbial organisms effectiveness defined as capable of killing at least about 85% of the population of an initial inoculation of one or more microbial organisms after seven days.

### Embodiment 150

The nonwoven article of Embodiment 146, wherein the nonwoven article comprises a persistent residual antimicrobial effectiveness against one or more microbial organisms defined as capable of killing at least about 85% of the population of an initial inoculation of E. coli after seven days, at least 85% of the population of an initial inoculation of K. pneumonia after seven days, and at least 95% of the population of an initial inoculation of S. aureus after seven days.

### Embodiment 151

The nonwoven article of Embodiment 145, wherein the antiviral agent comprises hydroxide, peroxide, ammonium, chlorine-containing compounds, chlorite, chlorate, carbonate, bicarbonate, ethanol, isopropanol, sulfur, lactic acid, dodecylbenzenesulfonic acid, citric acid, octanoic acid, hypochlorous acid, phenolic, dischloroisocyanurate, glutaraldehyde, peroxyacetic acid, peroxymonosulfate, a transition metal element, thymol, dichloro-S-triazinetrione, glycolic acid, triethylene glycol, or a combination thereof.

### Embodiment 152

The nonwoven article of Embodiment 151, wherein the antiviral formulation comprises a registered disinfectant efficacy against at least one of Group I double-stranded DNA viruses, Group II single-stranded DNA viruses, Group III double-stranded RNA genomes, Group IV positive-sense single-stranded RNA genomes, Group V negative-sense single-stranded RNA genomes, Group VI single-stranded RNA viruses replicating through DNA intermediates, Group VII double-stranded DNA genomes replicating through reverse transcriptase, or any combination thereof.

### Embodiment 153

The nonwoven article of Embodiment 151, wherein the antiviral formulation comprises a registered disinfectant efficacy against any RNA-based viruses.

### Embodiment 154

The nonwoven article of Embodiment 151, wherein the antiviral formulation comprises a registered disinfectant efficacy against Group IV positive-sense single-stranded RNA genomes.

### Embodiment 155

The nonwoven article of Embodiment 151, wherein the antiviral formulation comprises a registered disinfectant efficacy against viruses with an enveloped capsid.

### Embodiment 156

The nonwoven article of Embodiment 151, wherein the antiviral formulation comprises a registered disinfectant efficacy against viruses with a helical capsid symmetry.

### Embodiment 157

The nonwoven article of Embodiment 151, wherein the antiviral formulation comprises a registered disinfectant efficacy against viruses of the Nidovirales order.

### Embodiment 158

The nonwoven article of Embodiment 151, wherein the antiviral formulation comprises a registered disinfectant efficacy against viruses of the Coronaviridae family.

### Embodiment 159

The nonwoven article of Embodiment 151, wherein the antiviral formulation comprises a registered disinfectant efficacy against a virus of the Betacoronavirus genus.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A nonwoven article, comprising:
a nonwoven substrate comprising a lofty, open web of fibers; and
a coating overlying the nonwoven substrate, the coating having a greater thickness at an exterior surface of the nonwoven substrate as compared to a central region of the nonwoven substrate spaced apart from the exterior surface.

2. The nonwoven article of claim 1, wherein the thickness of the coating at the exterior surface of the nonwoven substrate is greater than the thickness of the coating at the central portion of the nonwoven substrate by at least about 1%, as at least 2%, at least 3%, at least 4%, at least 5%, at least 7.5%, at least 10%, at least 12.5%, at least 15%, at least 17.5%, at least 20%, at least 22.5%, at least 25%, at least 30%, or at least about 35%.

3. The nonwoven article of claim 2, wherein the thickness of the coating at the exterior surface of the nonwoven substrate is greater than the thickness of the coating at the central portion of the nonwoven substrate by not greater than about 50%, not greater than 40%, not greater than 35%, not greater than 30%, not greater than 25%, not greater than 22.5%, not greater than 20%, not greater than 17.5%, not greater than 15%, not greater than 12.5%, not greater than 10%, not greater than 7.5%, or not greater than about 5%.

4. The nonwoven article of claim 1, wherein the nonwoven article comprises a loft of at least 12 millimeters (mm), at least 13 mm, at least 14 mm, or at least 15 mm and not greater than 20 mm, not greater than 19 mm, not greater than 18 mm, not greater than 17 mm, or not greater than 16 mm.

5. The nonwoven article of claim 1, wherein the nonwoven article comprises an elongation percentage of at least 15%, at least 20%, or at least 25% and not greater than 75%, not greater than 70%, not greater than 65%, not greater then 60%, not greater than 55%, not greater than 50%, not greater than 45%, not greater than 40%, or not greater than 30%.

6. The nonwoven article of claim 1, wherein the nonwoven article comprises a tensile strength of at least 29 kilograms force (kgf), at least 30 kgf, at least 35 kgf, or at least 40 kgf and not greater than 60 kgf, not greater than 55 kgf, not greater than 50 kgf, or not greater than 45 kgf.

7. The nonwoven article of claim 1, wherein the nonwoven article comprises a toughness index (elongation percentage/tensile strength) of at least 0.5%/kgf, at least 0.6%/kgf, at least 0.7%/kgf, at least 0.8%/kgf, at least 0.9%/kgf, at least 1.0%/kgf, at least 1.25%/kgf, or at least 1.5%/kgf and not greater than 5%/kgf, not greater than 4%/kgf, not greater than 3%/kgf, not greater than 2%/kgf, not greater than 1.5%/kgf, or not greater than 1.0%/kgf.

8. The nonwoven article of claim 1, wherein the nonwoven article comprises a stiffness of at least 50,000 milligrams (mg), at least 60,000 mg, at least 70,000 mg, at least 80,000 mg, at least 90,000 mg, at least 100,000 mg, or at least 105,000 mg and not greater than 125,000 mg, not greater than 120,000 mg, or not greater than 115,000 mg.

9. The nonwoven article of claim 1, wherein the nonwoven article comprises a mean pore size of at least 50 micrometers (μm), such at least 70 μm, at least 90 μm, at least 110 μm, or at least 115 μm and not greater than 300 micrometers (μm), not greater than 200 μm, not greater than 150 μm, not greater than 140 μm, or not greater than 135 μm.

10. The nonwoven article of claim 1, wherein the nonwoven article comprises a permeability of at least 11 ft³/min/ft², such as at least 12 ft³/min/ft², or at least 13 ft³/min/ft² and not greater than 20 ft³/min/ft², such as not greater than 19 ft³/min/ft², not greater than 18 ft³/min/ft², not greater than 17 ft³/min/ft², or not greater than 16 ft³/min/ft².

11. The nonwoven article of claim 1, wherein the nonwoven article comprises an MD Orientation Factor of at least 1.0, such as at least 1.02, at least 1.04, at least 1.06, at least 1.08, at least 1.10, at least 1.12, at least 1.14, at least 1.16, or at least 1.18 and not greater than 2.0, such as not greater than 1.5, not greater than 1.25, not greater than 1.24, not greater than 1.23, or not greater than 1.22.

12. The nonwoven article of claim 1, wherein the nonwoven substrate comprises a blend of a plurality of fibers comprising a first type of fibers and a second type of fibers, and wherein the first type of fibers is different from the second type of fibers in composition, construction, denier, length, ratio, shape, thickness, type, or any combination thereof.

13. The nonwoven article of claim 12, wherein the plurality of fibers comprises:
5 to 95% of the first type of fibers; and
5 to 95% of the second type of fibers.

14. The nonwoven article of claim 13, wherein the nonwoven substrate is formed by a double needling process.

15. The nonwoven article of claim 1, wherein the coating comprises a first coating and a second coating.

16. The nonwoven article of claim 15, wherein the first coating comprises a dip coating and the second coating comprises a spray coating.

17. The nonwoven article of claim 16, wherein at least one of the first coating and the second coating comprises abrasive particles disposed in a polymeric binder composition.

18. The nonwoven article of claim 17, further comprising: an antimicrobial formulation comprising an antimicrobial agent, an antiviral formulation comprising an antiviral agent, or a combination thereof disposed on, in, or a combination thereof, the nonwoven substrate.

19. The nonwoven article of claim 18, wherein the antimicrobial agent comprises triclosan, triclocarban, polyhexamethylene biguanide, zinc pyrithione, salicylic acid, benzalkonium chloride, chloroxylenol, silver, bronopol, tannic acid, chitosan, or any combination thereof.

20. The nonwoven article of claim 18, wherein the antiviral agent comprises hydroxide, peroxide, ammonium, chlorine-containing compounds, chlorite, chlorate, carbonate, bicarbonate, ethanol, isopropanol, sulfur, lactic acid, dodecylbenzenesulfonic acid, citric acid, octanoic acid, hypochlorous acid, phenolic, dischloroisocyanurate, glutaraldehyde, peroxyacetic acid, peroxymonosulfate, a transition metal element, thymol, dichloro-S-triazinetrione, glycolic acid, triethylene glycol, or a combination thereof.
